(19) United States
(12) Patent Application Publication
(10) Pub. No.: US 2025/0123389 A1
(43) Pub. Date: Apr. 17, 2025

(54) INFORMATION PROCESSING DEVICE, INFORMATION PROCESSING METHOD, AND PROGRAM

(71) Applicant: Asahi Kasei Microdevices Corporation, Tokyo (JP)

(72) Inventors: Hiroki OGUSU, Tokyo (JP); Yasumi NAKAMURA, Tokyo (JP)

(21) Appl. No.: 18/911,268

(22) Filed: Oct. 10, 2024

(30) Foreign Application Priority Data
Oct. 12, 2023 (JP) 2023-176681
Jul. 24, 2024 (JP) 2024-118539

(51) Int. Cl. G01S 13/86; G01S 13/08; G01S 13/58

(52) U.S. Cl. CPC G01S 13/86; G01S 13/08; G01S 13/58

(57) ABSTRACT

An information processing device is provided, including a data acquisition unit that emits an electromagnetic wave to a target object and acquires measurement data generated from a reflected wave from the target object and a conversion condition determination unit that determines whether the conversion condition to convert at least a part of the measurement data into sound data is met; and a data conversion unit that converts at least a part of the measurement data into the sound data if the conversion condition is met. The conversion condition determination unit may determine whether the conversion condition is met based on the measurement data.

The contents of the following patent application(s) are incorporated herein by reference:
NO. 2023-176681 filed in JP on Oct. 12, 2023 and
NO. 2024-118539 filed in JP on Jul. 24, 2024.

### BACKGROUND

### 1. Technical Field

The present invention relates to an information processing device, an information processing method, and a program.

### 2. Related Art

Conventionally, a device for measuring a sound from a target object is known (for example, see Patent Document 1). In addition, a method for sensing a target object by using an FMCW radar is known (for example, see Patent Document 2).
Patent Document 1: Chinese Patent Application Publication No. 102961164
Patent Document 2: Japanese Patent Application Publication No. 2022-192005

### BRIEF DESCRIPTION OF THE DRAWINGS

FIG. 1A is a diagram illustrating an overview of a configuration of a system 300 that acquires sound data of a target object 12.

FIG. 1B is a diagram illustrating a relative position between the target object 12 and a measurement device 100.

FIG. 1C is a diagram illustrating one example of a representative plane of the target object 12.

FIG. 1D is a diagram illustrating one example of an azimuth and a relative azimuth.

FIG. 2 is a schematic diagram illustrating one example of a measurement range 400 to which the measurement device 100 emits a transmission wave.

FIG. 3 is a block diagram illustrating a configuration example of an information processing device 10.

FIG. 4 is a block diagram illustrating a configuration example of a data processing unit 30.

FIG. 5 is a diagram illustrating one example of the transmission wave emitted by a transmission unit 120.

FIG. 6 is a diagram illustrating a transmission signal 220, a reception signal 230 obtained from a reflected wave, and an intermediate signal 150.

FIG. 7 is a diagram illustrating the distance R, the velocity V, and the azimuth θ of the target object 12.

FIG. 8 is a diagram illustrating the distance R, the velocity V, the azimuth θ1, and the azimuth θ2 of the target object 12.

FIG. 9 is a diagram illustrating the operating principle of a system 300.

FIG. 10 is a diagram illustrating the principle for sensing the distance R to the target object 12.

FIG. 11A is a diagram illustrating the principle for sensing the azimuth θ of the target object 12.

FIG. 11B is a diagram illustrating a process for sensing the azimuth θ of the target object 12 by angular FFT.

FIG. 12 is a diagram illustrating the principle for sensing the velocity V of the target object 12.

FIG. 13 is a diagram illustrating one example of the temporal waveform of the intermediate signal converted to a digital signal.

FIG. 14 is a diagram illustrating one example of the operation of the conversion condition determination unit 40.

FIG. 15 is a diagram illustrating another example of the operation of the conversion condition determination unit 40.

FIG. 16 is a diagram illustrating one example of azimuth information.

FIG. 17 is a diagram illustrating one example of an IQ plot in a peak bin PB of the intermediate signal.

FIG. 18 is a diagram illustrating one example of velocity information.

FIG. 19A is a diagram illustrating one example of sound data converted from measurement data.

FIG. 19B is a diagram illustrating one example of the sound data converted from the measurement data.

FIG. 19C is a diagram illustrating the effect of the relative azimuth of the target object 12 and the measurement device 100 on the amplitude of the reflected wave.

FIG. 19D illustrates the time series data of the absolute value |max| of the maximum amplitude in the intermediate signal, like FIG. 14.

FIG. 19E is a diagram illustrating the effect of the relative azimuth Or of the target object 12 and the measurement device 100 on the phase variation amount.

FIG. 19F illustrates an example in which the position of the representative plane 13 on the target object 12-2 varies in the direction of a normal vector b.

FIG. 20 is a diagram illustrating one example of data map 410 generated by a conversion condition determination unit 40.

FIG. 21 is a diagram illustrating one example of a combined data map 420 generated by the conversion condition determination unit 40.

FIG. 22 is a diagram illustrating another example of the data map 410 generated by the conversion condition determination unit 40.

FIG. 23A is a block diagram illustrating another configuration example of the information processing device 10.

FIG. 23B is a diagram illustrating the temporal change in the relative position of the target object 12 obtained from distance information and azimuth information.

FIG. 24 is a flowchart illustrating one example of the operation of a system 300.

FIG. 25 illustrates an example of a computer 1200 in which a plurality of aspects of the present invention may be wholly or partially embodied.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solution of the invention.

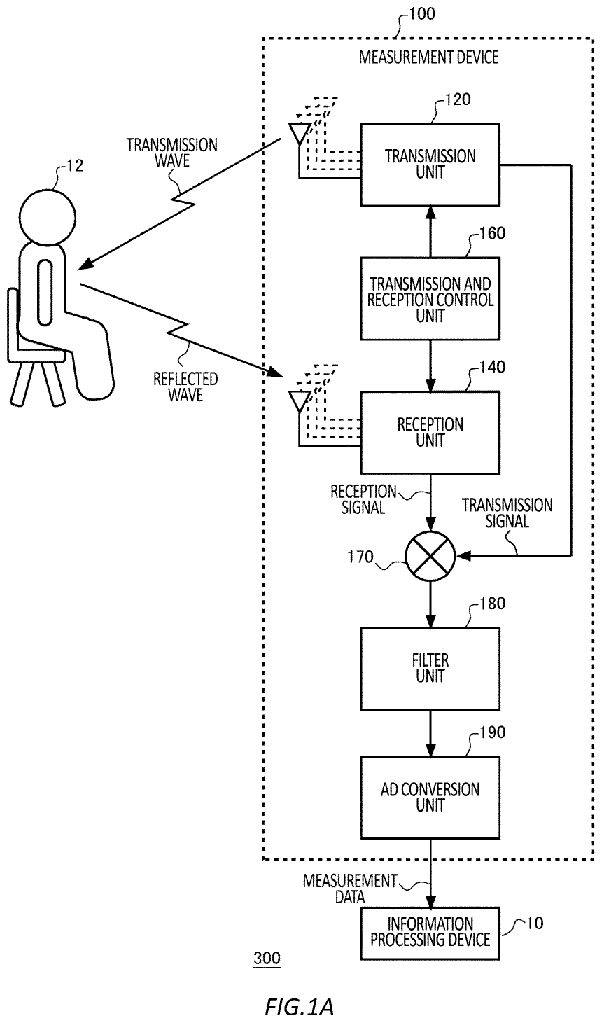

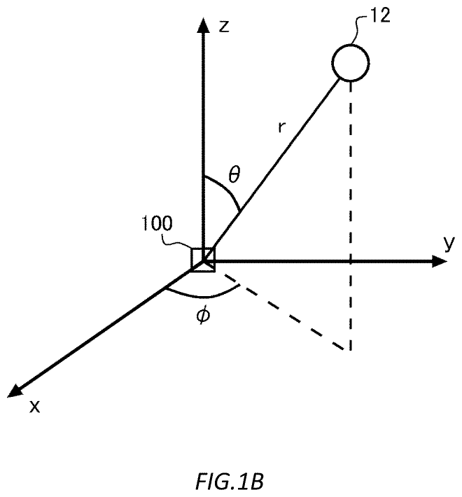

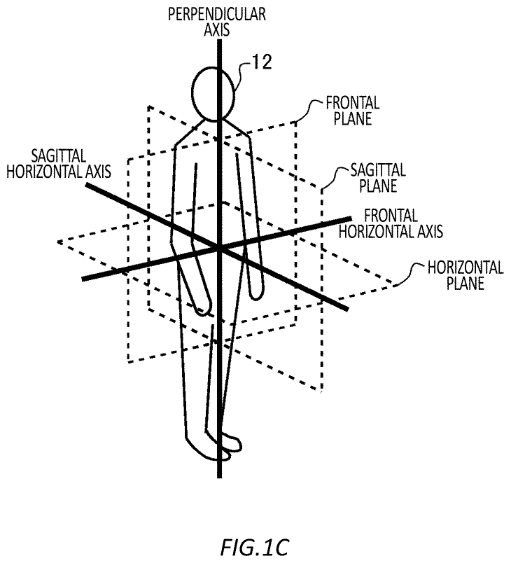

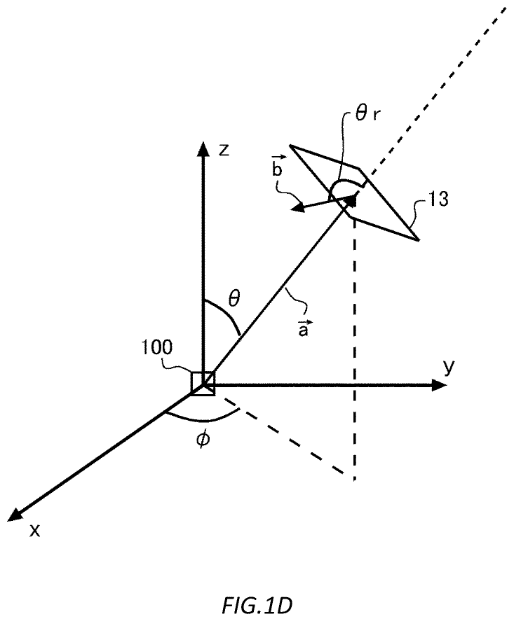

FIG. 1A is a diagram illustrating an overview of a configuration of a system 300 that acquires sound data of a target object 12. The target object 12 produces the sound of a measurement target. The sound may be periodically produced. At least a part of the target object 12 vibrates and shifts its position in the space when the sound is produced. As one example, the target object 12 is an organism such as a human or an animal. In addition, as one example, the sound of the measurement target is a body sound produced by the activity of the body such as a heart sound or a lung sound. In this case, the skin in the vicinity of the heart or lung of the target object 12 vibrates according to the movement of the heart or the lung. It is noted that the target object 12 and the sound of the measurement target are not limited to the above-described example. The body sound of the measurement target may be a breathing sound of a respiratory tract, a peristalsis sound of a bowel, a swallowing sound, or the like. In these cases, the skin in the vicinity of the neck or bowel of the target object 12 vibrates.

The system 300 includes a measurement device 100 and an information processing device 10. The measurement device 100 measures the temporal variation in the distance from the measurement device 100 to at least a part of the target object 12. The part of the target object 12 that is the measurement target for the distance variation is the surface of the target object 12 in the vicinity of the portion where the sound is produced in the target object 12, for example. The measurement device 100 measures the temporal variation in the spatial position of the surface. For example, the measurement device 100 measures the vibration of the chest skin of a person. The measurement device 100 outputs the measurement data indicating the measurement result. The frequency component of the shift of the target object 12 measured by the measurement device 100 includes the frequency component of the sound produced by the target object 12. The information processing device 10 converts at least a part of the measurement data of the measurement device 100 into sound data.

The measurement device 100 in the present example emits the transmission wave, which is an electromagnetic wave, to the target object 12 and measures the reflected wave from the target object 12. The time from emitting the transmission wave to receiving the reflected wave changes according to the distance from the measurement device 100 to the target object 12. The time is also referred to as Time of Flight (TOF). The distance from the measurement device 100 to the target object 12 can be measured by measuring the reflected wave.

The measurement device 100 may emit a transmission wave the frequency of which gradually changes. In this case, the frequency of the transmission wave that is being emitted when the reflected wave is received changes according to the distance from the measurement device 100 to the target object 12. Therefore, the frequency difference between the emitted transmission wave and the received reflected wave indicates the distance from the measurement device 100 to the target object 12. The vibration of the target object 12 can be measured by observing the frequency difference and the phase difference between the emitted transmission wave and the received reflected wave.

The measurement data output by the measurement device 100 includes the result of measuring the reflected wave. The measurement result of the reflected wave includes the information indicating the temporal change in the distance to the target object 12. As one example, the measurement data includes the data indicating the temporal variation in the frequency difference between the transmission wave and the reflected wave. The measurement data may be a baseband signal. It is noted that the measurement device 100 is not limited to those that gradually change the frequency of the emitted transmission wave, provided that it can measure the distance to the target object 12 based on the reflected wave.

The information processing device 10 converts at least a part of the measurement data into sound data. The sound data includes the data for reproducing at least one of the temporal waveform or the frequency spectrum of the sound of the measurement target. The sound data may be at least one of the temporal waveform or the frequency spectrum of the sound of the measurement target. The information processing device 10 may calculate the positional variation of the target object 12 based on the measurement data. The information processing device 10 may extract the component of the frequency band, among the frequency component of the positional variation of the target object 12, to be converted into the sound data and convert it to the sound data. The frequency band may be determined according to the type of sound to be the target. For example, when the heart sound is measured, the information processing device 10 may set the frequency band including 100 Hz. When the lung sound is measured, the information processing device 10 may set the frequency band including 100 Hz to 800 Hz.

The information processing device 10 may play the sound based on the generated sound data, may display at least a part of the temporal waveform or the frequency spectrum of the sound, or may transmit the sound data to the outside. For example, the information processing device 10 may transmit the sound data to the terminal of the doctor at a remote location. The terminal of the doctor plays the sound based on the sound data. Thus, medical care at a remote location can be assisted.

The information processing device 10 of the present example determines whether the conversion condition to convert at least a part of the measurement data into the sound data is met. If the conversion condition is met, the information processing device 10 converts at least a part of the measurement data into the sound data indicating the sound of the measurement target such as a body sound, for example.

The conversion condition is a condition to determine whether appropriate sound data can be acquired, for example. Depending on the relative position or the relative azimuth of the target object 12 and the measurement device 100, the amplitude of the reflected wave is so small that the appropriate sound data sometimes cannot be acquired. In addition, if only the positional shift that does not correlate with the production of the sound of the measurement target is measured, the positional shift indicated in the reflected wave does not correspond to the sound of the measurement target and the appropriate sound data cannot be acquired. The relative position and the relative azimuth of the target object 12 and the measurement device 100 will be described below.

The conversion condition may be the condition in which the amplitude of the reflected wave is specified or may be another condition. The information processing device 10 generates the sound data corresponding to the sound of the measurement target only when the conversion condition is met, which can prevent the generation of unnecessary sound data.

Generating the sound data when the conversion condition is met refers to generating the sound data to be provided to the user. The information processing device 10 may determine whether the sound data temporarily generated meets the conversion condition and provides only the sound data meeting the conversion condition to the user. The sound data not meeting the conversion condition may be discarded by the information processing device 10 or may be accumulated in the information processing device 10. The sound data generated when the conversion condition is met may be recorded in the information processing device 10 as the sound data that can be provided to the user.

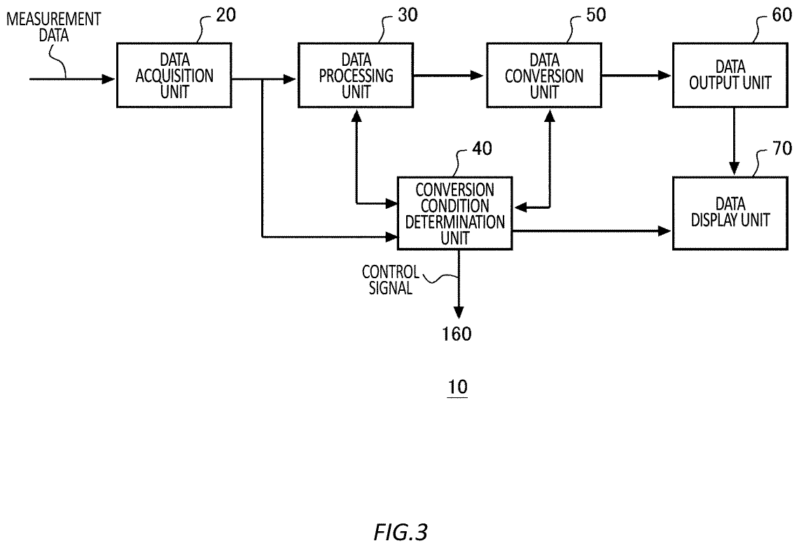

The information processing device 10 may perform a conversion process from the measurement data into the sound data if the conversion condition is met. The conversion process from the measurement data into the sound data may include the process of generating the information according to the distance to the target object 12 from the measurement data. The conversion process may include the process of extracting the temporal variation in the phase of the signal included in the measurement data. The conversion process may include the filtering process of the signal included in the measurement data according to the frequency band of the sound of the measurement target. The conversion process may include the Fourier transform of the signal included in the measurement data. The conversion process may include at least a part of the processes among the determination processes 1 to 10 described below. The details of the conversion process will be described in FIG. 3 and onward. The conversion process from the measurement data into the sound data includes at least a part of the processes described in FIG. 3 and onward.

The information processing device 10 generates the sound data only when the conversion condition is met, which can efficiently provide the sound data to a user such as a doctor. For example, it can reduce the effort for the user to select the appropriate sound data from a large amount of the sound data. In addition, it continues to monitor whether the conversion condition is met and automatically acquires the sound data for which the conversion condition is met, which can eliminate the need for a healthcare provider to intervene until the sound data is acquired. The healthcare provider can start the medical care after the sound data starts to be acquired or can subsequently analyze the automatically acquired sound data to efficiently perform the medical care.

The information processing device 10 may analyze the automatically acquired sound data to determine whether an abnormality occurs in the heart sound or the like. With the information processing device 10, the appropriate sound data of the target object 12 can also be automatically acquired in the daily life of the target object 12. For example, the measurement device 100 may be provided on an apparatus such as a mirror, a computer, a TV, a chair, a car, or the like, where the target object 12 remains stationary at a predetermined relative position. The information processing device 10 may notify an external organization such as a medical organization if it senses the abnormality. The measurement device 100 may be installed at places other than the home of the target object 12. For example, the measurement device 100 may be installed at a pharmacy or a retail store. In addition, the sound data of the target object 12 can be acquired in the space separated from a healthcare provider in a hospital. Therefore, the infection of disease from the target object 12 to the healthcare provider can be prevented.

If the target object 12 is an animal other than a human, it is difficult to keep the target object 12 stationary. Therefore, in general, it is difficult to acquire the sound data of the body sound from an animal. For example, in an animal hospital or the like, the target object 12 is in an excited state, which makes it difficult to keep the target object 12 stationary. With the information processing device 10, since the sound data from the target object 12 can be acquired at home or the like, appropriate sound data can be relatively easily acquired. For example, the appropriate sound data can be easily acquired by acquiring the sound data while the target object 12 is sleeping.

The measurement device 100 may emit the transmission wave to a predetermined measurement range and measure the reflected wave from several points within the measurement range. Thus, the information processing device 10 can acquire the sound data at several points of the target object 12. The information processing device 10 may generate the information indicating whether the appropriate sound data has been acquired for each of the several points. As a result, the medical care using the sound data becomes easy.

If the conversion condition is not met, the information processing device 10 may suppress the consumption of electric power in at least one of the measurement device 100 or the information processing device 10. Thus, the electric power consumption can be reduced.

The measurement device 100 in the present example includes a transmission unit 120 and a reception unit 140. The transmission unit 120 of the present example emits the transmission wave to the target object 12. The transmission wave of the present example is a Frequency Modulated Continuous Wave (FMCW) but is not limited thereto. The transmission wave of the present example includes temporally repeated chirp in which the frequency is temporally swept. The transmission unit 120 may have a plurality of transmission antennas, each of which emits the transmission wave.

The reception unit 140 receives the reflected wave of the transmission wave that is reflected on the target object 12. The reception unit 140 may generate an electric signal according to the temporal waveform of the reflected wave. The reception unit 140 may have a plurality of reception antennas. A plurality of combinations of the transmission antenna and the reception antenna are provided so that the information related to the azimuth θ of the target object 12 viewed from the measurement device 100 can be acquired. For example, if a plurality of reception antennas are provided, the phase of the reflected wave that reaches each reception antenna changes according to the azimuth θ of the target object 12 and the position of the reception antenna. Since the position of each reception antenna is known, the azimuth θ of the target object 12 can be sensed based on the phase of the reflected wave received by each reception antenna.

A transmission and reception control unit 160 controls the transmission and reception of a signal by the transmission unit 120 and the reception unit 140. In one example, the transmission and reception control unit 160 controls at least one of the modulation width of the frequency, the period, or the repeat count of the chirp included in the transmission wave.

The measurement device 100 of the present example further includes an intermediate signal generation unit 170, a filter unit 180, and an AD conversion unit 190. The intermediate signal generation unit 170 generates the intermediate signal having a frequency according to the difference between the frequency of the reflected wave and the frequency of the transmission wave. The intermediate signal has the amplitude according to the amplitude of the reflected wave. The maximum amplitude of the intermediate signal may be the same as or proportional to the maximum amplitude of the reflected wave. The intermediate signal generation unit 170 may generate the intermediate signal for each combination of the transmission antenna and the reception antenna. For example, if A transmission antennas and B reception antennas are provided, the intermediate signal generation unit 170 may generate A×B intermediate signals. In this case, there may be B intermediate signal generation units 170.

The intermediate signal generation unit 170 of the present example is a mixer that multiplies the transmission signal according to the transmission wave transmitted by the corresponding transmission antenna by the reception signal according to the reflected wave received by the corresponding reception antenna. By multiplying two signals, an intermediate signal having a frequency of the difference between the frequency of the reflected wave and the frequency of the transmission wave and a sum frequency signal having a frequency of the sum can be generated. The frequency of the intermediate signal increases as the distance between the measurement device 100 and the target object 12 increases.

The filter unit 180 restricts the frequency band of the signal output by the intermediate signal generation unit 170. The filter unit 180 of the present example passes the intermediate signal among the signal output by the intermediate signal generation unit 170 and removes the sum frequency signal. Thus, the intermediate signal can be extracted. In addition, the filter unit 180 may remove the short-distance signal with relatively high signal intensity using a high-pass filter. Thus, the saturation of the internal signal can be prevented and the distance range that can be measured can be increased. As described above, the intermediate signal may only have to have a frequency according to the difference between the frequency of the reflected wave and the frequency of the transmission wave. Thus, the distance to the target object 12 can be detected from the intermediate signal. In the present specification, signals based on the intermediate signal, such as those obtained by performing at least one of the additions of any frequency property by the filter unit 180 or the like or the adjustment of gain on the intermediate signal output by the intermediate signal generation unit 170, are also referred to as the intermediate signal.

The AD conversion unit 190 converts the intermediate signal output by the filter unit 180 into a digital signal. The measurement device 100 outputs the measurement data including the digital signal converted by the AD conversion unit 190. The information processing device 10 of the present example generates the sound data based on at least a part of the frequency component of the intermediate signal included in the measurement data.

FIG. 1B is a diagram illustrating the relative position of the target object 12 and the measurement device 100. In the present specification, the relative position of the target object 12 and the measurement device 100 indicates the relative positional relationship between the target object 12 and the measurement device 100. For example, as illustrated in FIG. 1B, when any Cartesian coordinate system (x-axis, y-axis, z-axis) is defined with the position of the measurement device 100 at the origin, the relative position is indicated by the distance r of the target object 12 from the origin and the angle θ and the angle ϕ with the two coordinate axes (for example, z-axis and x-axis). In addition, in the present specification, the above-described relative position is sometimes merely denoted as a position. In the present specification, the relative azimuth of the target object 12 and the measurement device 100 refers to the angle between the normal vector of any representative plane defined on the target object 12 and the direction vector from the measurement device 100 to the target object 12.

FIG. 1C is a diagram illustrating one example of the representative plane of the target object 12. The target object 12 of the present example is a person. The plane that is perpendicular to the ground and divides the person into left and right halves is referred to as a sagittal plane, the plane that is perpendicular to the ground and divides the person into front and back halves is referred to as a frontal plane, and the plane that is parallel to the ground and divides the person into upper and lower halves is referred to as a horizontal plane. In addition, the axis perpendicular to the ground is referred to as a perpendicular axis, the axis perpendicular to the frontal plane is referred to as a sagittal horizontal axis, and the axis perpendicular to the sagittal plane is referred to as a frontal horizontal axis.

If the target object 12 is a person, the representative plane may be the frontal plane and its normal vector may be in the front direction of the sagittal horizontal axis. In addition, as the direction vector from the target object 12 to the measurement device 100, a vector with the start point at the center of gravity of the target object 12 and the end point at the center of gravity of the measurement device 100 may be defined. In addition, the magnitudes of the above-described normal vector and direction vector are arbitrary. In this case, the relative azimuth changes depending on the posture of a person as the target object 12. In this case, the change in the posture includes the movement of the forward bending, backward bending, rotation, and lateral bending of the body as well as the movement of the arm, leg, or neck.

In the present specification, the direction of the direction vector from the measurement device 100 to the target object 12 is referred to as the azimuth of the target object 12 viewed from the measurement device 100 or simply the azimuth, and the angle between the normal vector of any representative plane defined on the target object 12 and the direction vector from the measurement device 100 to the target object 12 is referred to as the relative azimuth of the target object 12 and the measurement device 100 or simply the relative azimuth.

FIG. 1D is a diagram illustrating one example of the azimuth and the relative azimuth. FIG. 1D illustrates the measurement device 100 and the representative plane 13 of the target object 12 in the xyz coordinate system. In addition, FIG. 1D illustrates the direction vector a from the measurement device 100 to the target object 12 and the normal vector b of the representative plane 13. In FIG. 1D, an arrow is added to the top of each vector symbol but the description of the arrow is omitted in the specification.

For example, in FIG. 1D, the azimuth of the target object 12 viewed from the measurement device 100 is defined by the angle θ between the direction vector a and the z-axis and the angle ϕ between the x-axis and the line obtained by projecting the direction vector a on the xy-plane. The relative azimuth of the target object 12 and the measurement device 100 is defined by the angle θr between the normal vector b of the representative plane 13 of the target object 12 and the direction vector a from the measurement device 100 to the target object 12.

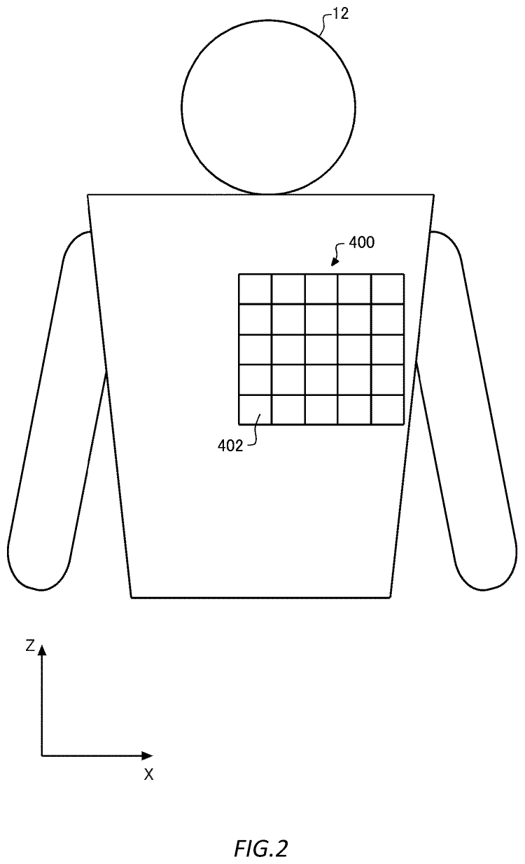

FIG. 2 is a schematic diagram illustrating one example a measurement range 400 to which the measurement device 100 emits a transmission wave. The target object 12 of the present example is a person. The measurement device 100 in the example of FIG. 2 emits the transmission wave to the vicinity of the chest of the target object 12.

Regardless of the presence of the target object 12, the measurement device 100 may continue to emit the transmission wave toward the predetermined measurement range 400 and measure the reflected wave from the azimuth of the measurement range 400. The transmission wave emitted by the measurement device 100 may have a wavelength that passes through clothes and is reflected on the skin of an organism. The transmission wave may be a so-called millimeter wave. The wavelength of the transmission wave may be equal to or more than 1 mm and equal to or less than 10 mm.

If the measurement range 400 includes the portions that shift according to the body sound from the target object 12, such as the chest, the sound data of the body sound can be generated from the reflected wave from the measurement range 400. On the other hand, if the measurement range 400 does not include the portion, the appropriate sound data cannot be generated from the reflected wave from the measurement range 400. Because the system 300 of the present example generates the sound data from the reflected wave and records it if the conversion condition is met, it can prevent the generation of sound data that is not appropriate.

The measurement range 400 may be divided into a plurality of regions 402. The shift of each region 402 affects the phase of one or more reflected waves. The information processing device 10 can measure the shift of the target object 12 for each region 402 by analyzing the reflected wave received by a plurality of reception antennas.

The information processing device 10 may determine whether the reflected wave meets the conversion condition for each region 402. In this case, the information processing device 10 generates the sound data from the reflected wave that meets the conversion condition. The information processing device 10 may record the generated sound data in association with the region 402.

The information processing device 10 may determine whether the reflected wave received by one or more reception antennas meets the conversion condition. For example, it may determine whether the reflected wave received by the reception antenna disposed in the center among a plurality of reception antennas arranged in a predetermined direction meets the conversion condition. In this case, the information processing device 10 may generate the sound data for all the regions 402 if the reflected wave received by one reception antenna meets the conversion condition. The information processing device 10 may record the generated sound data in association with each region 402.

In the present specification, the plane parallel to the measurement range 400 is referred to as the X-Z plane. In addition, the axis parallel to the direction from the measurement device 100 to the target object 12 is referred to as the Y-axis. The X-axis, the Y-axis, and the Z-axis are the axes orthogonal to each other. The Z-axis is parallel to the gravity direction as one example. FIG. 3 is a block diagram illustrating a configuration example of the information processing device 10. The information processing device 10 includes a data acquisition unit 20, a conversion condition determination unit 40, and a data conversion unit 50. The information processing device 10 of the present example further includes a data processing unit 30, a data output unit 60, and a data display unit 70. The information processing device 10 and the measurement device 100 may be provided in the same housing or may be provided in different housings. The information processing device 10 may be a computer for processing a digital signal. A single computer may function as each component illustrated in FIG. 3 or a plurality of computers may work together to function as each component illustrated in FIG. 3.

The data acquisition unit 20 acquires the measurement data generated from the reflected wave from the target object 12 that occurs when the transmission wave is emitted to the target object 12. The measurement data may include the data of a plurality of intermediate signals corresponding to a plurality of reflected waves obtained for each transmission and reception channel. The transmission and reception channel refers to the combination of the transmission antenna and the reception antenna. The data acquisition unit 20 of the present example acquires the measurement data from the measurement device 100. The data acquisition unit 20 may include a communication device performing the communication with the measurement device 100.

The data processing unit 30 performs the predetermined data processing on the measurement data. For example, the data processing unit 30 calculates the variation (that is, the shift) of the position of the target object 12 in each region 402 based on the measurement data. The data processing unit 30 may perform at least one of the following processes on each intermediate signal included in the measurement data: gain adjustment, Fast Fourier Transform (FFT), or filtering. The details of the data processing in the data processing unit 30 will be described below.

The conversion condition determination unit 40 determines whether the conversion condition to convert at least a part of the measurement data into the sound data is met. The conversion condition determination unit 40 of the present example determines the conversion condition based on at least one of the reflected wave included in the measurement data, the intermediate signal included in the measurement data, the data output by the data processing unit 30, the data on which at least a part of the processes have been performed in the data processing unit 30, the data on which at least a part of the processes have been performed in the data conversion unit 50, or the sound data generated by the data conversion unit 50. The details of the determination process in the conversion condition determination unit 40 will be described below. The conversion condition determination unit 40 may determine whether the conversion condition is met based on information, such as the image of the target object 12, other than the measurement data.

If the conversion condition is met, the conversion condition determination unit 40 of the present example outputs the control signal to control at least one of the transmission wave or the information processing device 10 so that at least one of the electric power consumption for emitting the transmission wave or the electric power consumption of the information processing device 10 increases compared to before the conversion condition is met. The conversion condition determination unit 40 may set the frequency of emitting the transmission wave after the conversion condition is met to be higher than the frequency of emitting the transmission wave before the conversion condition is met. The conversion condition determination unit 40 may set the transmission power of the transmission wave after the conversion condition is met to be higher than the transmission power before the conversion condition is met. The conversion condition determination unit 40 may stop at least a part of the data processing in at least one of the data processing unit 30 or the data conversion unit 50 before the conversion condition is met. The conversion condition determination unit 40 may keep the data processing unit 30 and the data conversion unit 50 inactivated before the conversion condition is met, and activate the data processing unit 30 and the data conversion unit 50 if the conversion condition is met. The conversion condition determination unit 40 may output the control signal to control at least one of the transmission wave or the information processing device 10 so that at least one of the electric power consumption for emitting the transmission wave or the electric power consumption of the information processing device 10 decreases after a certain time period elapses since the conversion condition is met. For example, if the conversion condition is met, the conversion condition determination unit 40 increases at least one of the electric power consumption for emitting the transmission wave or the electric power consumption of the information processing device 10 relative to the initial value. When a certain time period elapses since the conversion condition is met, the conversion condition determination unit 40 may reset the electric power consumption for emitting the transmission wave and the electric power consumption of the information processing device 10 to the initial value. The certain time period may be within ten seconds, may be within one minute, or may be longer time. The certain time period may be the time required for auscultation by a physician or the like. The certain time period may be able to be preset by a user such as a physician.

In another example, the conversion condition determination unit 40 may output the control signal to control the transmission wave and the information processing device so that at least one of the electric power consumption for emitting the transmission wave or the electric power consumption of the information processing device do not change before and after the conversion condition is met. The conversion condition determination unit 40 may keep the frequency of emitting the transmission wave the same before and after the conversion condition is met. The conversion condition determination unit 40 may keep the transmission power of the transmission wave the same before and after the conversion condition is met. The conversion condition determination unit 40 may not stop a part of the data processing in the data processing unit 30 and the data conversion unit 50 even before the conversion condition is met. The conversion condition determination unit 40 may not reduce the electric power supply to the data processing unit 30 and the data conversion unit 50 even before the conversion condition is met.

In another example, if the conversion condition is met, the conversion condition determination unit 40 may output the control signal to control the electromagnetic wave so that the emission amount per unit time of the electromagnetic wave emitted toward the target object 12 increases compared to before the conversion condition is met. The emission amount may be the time integral value of the intensity of the electromagnetic wave toward the target object 12. In the present example, the emission amount of the electromagnetic wave to the target object 12 is small while the conversion condition is not met. Thus, the effect of the electromagnetic wave on the target object 12 can be reduced.

As described above, the conversion condition determination unit 40 may control the emission amount of the electromagnetic wave emitted toward the target object 12 by controlling at least one of the frequency of emitting the transmission wave or the transmission power per one emission. In this case, the electric power consumption for emitting the transmission wave can be reduced while reducing the effect of the electromagnetic wave on the target object 12.

The conversion condition determination unit 40 may increase or decrease the emission amount of the electromagnetic wave emitted toward the target object 12 before and after the conversion condition is met, while at least one of the electric power consumption for emitting the transmission wave or the electric power consumption of the information processing device is maintained. For example, a plurality of transmission antennas of the measurement device 100 may include a dummy transmission antenna. The dummy transmission antenna emits the electromagnetic wave in a direction that is not toward the target object 12. The conversion condition determination unit 40 may increase or decrease the electric power consumption by the dummy transmission antenna before and after the conversion condition is met, while the total electric power consumption of the plurality of transmission antennas is maintained. More specifically, if the conversion condition is met, the electric power consumption in the dummy transmission antenna is decreased and the electric power consumption in the transmission antennas other than the dummy is increased, compared to if the conversion condition is not met. The electric power consumption in the dummy transmission antenna may be zero if the conversion condition is met. According to the present example, since the electric power consumption can be maintained, the effect of the electromagnetic wave on the target object 12 can be reduced while reducing the noise that occurs due to the variation of the electric power consumption.

In the above-described example, in the control to increase or decrease the emission amount of electromagnetic waves emitted toward the target object 12, the conversion condition determination unit 40 maintains or decreases the electric power consumption in the case where the conversion condition is not met, compared to the case where the conversion condition is met. In another example, in the control to increase or decrease the emission amount of electromagnetic waves emitted toward the target object 12, the conversion condition determination unit 40 may also increase the electric power consumption in the case where the conversion condition is not met, compared to the case where the conversion condition is met. These controls can decrease the emission amount of electromagnetic waves toward the target object 12.

If the conversion condition determination unit 40 determines that a predetermined conversion condition is met, the data conversion unit 50 converts at least a part of the measurement data into the sound data. The intermediate signal of the present example includes the information indicating the position of the target object 12. The data conversion unit 50 may convert the signal indicating the temporal variation of the position of the target object 12 calculated from the intermediate signal into the sound data. The data conversion unit 50 may convert the component in a predetermined frequency band among the signal indicating the temporal variation of the position of the target object 12 into the sound data.

If the conversion condition determination unit 40 determines that only a part of the intermediate signal meets the conversion condition in the case where the measurement data includes a plurality of intermediate signals, the data conversion unit 50 may convert the intermediate signal meeting the conversion condition into the sound data and not convert the other intermediate signals into the sound data. In another example, if it is determined that a part of the intermediate signals meets the conversion condition, the data conversion unit 50 may convert all the intermediate signals included in the measurement data into the sound data.

The data output unit 60 outputs the sound data converted by the data conversion unit 50. The data output unit 60 may output the sound data to the data display unit 70. The data display unit 70 includes a display device. The data display unit 70 displays the information related to the sound data. The data display unit 70 may display the temporal waveform of the sound data, may display the frequency spectrum, or may display the information indicating whether the corresponding sound data exists for each region 402.

The data output unit 60 may play the sound based on the sound data recorded by the data conversion unit 50. The data output unit 60 may transmit the sound data recorded by the data conversion unit 50 to an external device. For example, the data output unit 60 transmits the sound data to a terminal of a doctor in a remote location from the target object 12. The data output unit 60 may further transmit the information indicating whether the corresponding sound data exists for each region 402.

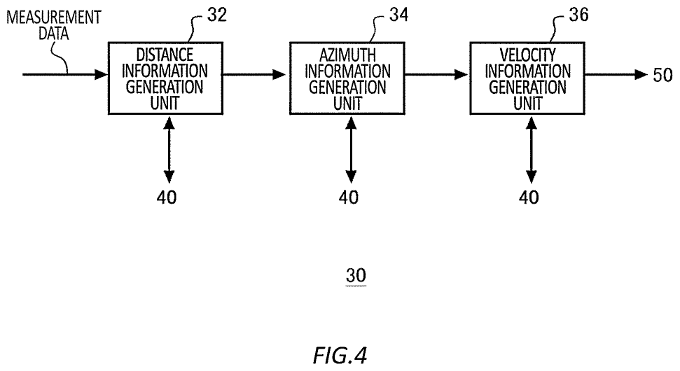

FIG. 4 is a block diagram illustrating a configuration example of the data processing unit 30. The data processing unit 30 of the present example has a distance information generation unit 32, an azimuth information generation unit 34, and a velocity information generation unit 36. It is noted that the connection sequence of the azimuth information generation unit 34 and the velocity information generation unit 36 may be opposite to the connection in FIG. 4.

The distance information generation unit 32 generates distance information indicating the distance to the target object 12 based on the reflected wave included in the measurement data. The distance information generation unit 32 of the present example generates the distance information from the intermediate signal generated from the reflected wave. In the present specification, the intermediate signal is treated as a signal of a reflected wave. The distance information generation unit 32 may generate the distance information based on the frequency of the intermediate signal. The distance information generation unit 32 generates the distance information for each intermediate signal.

The conversion condition determination unit 40 may determine whether the distance information meets the conversion condition. For example, the conversion condition determination unit 40 may determine whether the distance to the target object 12 indicated in the distance condition is within a predetermined range appropriate for measuring sounds. The range may be preset in the conversion condition determination unit 40.

The conversion condition determination unit 40 may determine whether the conversion condition is met based on the distance information corresponding to any of one or more intermediate signals. For example, it may determine whether the distance information corresponding to a reception antenna disposed at the center among a plurality of reception antennas meets the conversion condition. If the conversion condition determination unit 40 determines that the distance information does not meet the conversion condition, the information processing device 10 may not generate the sound data for all the data included in the measurement data. If the conversion condition determination unit 40 determines that the distance information does not meet the conversion condition, it may stop the process on the measurement data in the azimuth information generation unit 34 and the velocity information generation unit 36. If the conversion condition determination unit 40 determines that the distance information meets the conversion condition, it may perform the process on the measurement data in the azimuth information generation unit 34.

The azimuth information generation unit 34 generates the azimuth information based on a plurality of pieces of distance information corresponding to a plurality of intermediate signals. The azimuth information is information indicating the azimuth where the target object 12 exists relative to the measurement device 100. The azimuth information may be information indicating in which azimuth the portion in the target object 12 vibrating according to a sound exists. As described above, according to the azimuth in which the target object 12 exists, a phase difference occurs among the reflected waves received by respective reception antennas. The distance information of the present example includes information of the phase of each intermediate signal. The azimuth information generation unit 34 can calculate, from a plurality of pieces of distance information, the azimuth in which the target object 12 exists. The conversion condition determination unit 40 may extract the intermediate signal to be converted into the sound data based on the azimuth information.

The velocity information generation unit 36 generates velocity information based on the temporal variation in the distance information corresponding to the azimuth in which the reflected wave of the target object 12 is received. Since the distance information includes the information indicating the distance to the target object 12, the shift velocity of the target object 12 can be calculated from the temporal variation in the distance to the target object 12 indicated in the distance information.

The conversion condition determination unit 40 may extract the intermediate signal to be converted into the sound data based on the velocity information. In addition to the information related to the shift of the target object 12 related to the sound data of the measurement target, the velocity information also includes the information related to the shift of the target object 12 that does not relate to the sound data of the measurement target.

The conversion condition determination unit 40 may determine whether the information related to the shift of the target object 12 related to the sound of the measurement target among the velocity information meets the conversion condition. The conversion condition determination unit 40 may determine whether the component of the frequency band corresponding to the sound of the measurement target among the velocity information meets the conversion condition. For example, when a heart sound is measured, the frequency band may be equal to or more than 30 Hz and equal to or less than 100 Hz. The velocity information generation unit 36 may output, to the data conversion unit 50, the intermediate signal for which the velocity information is determined to meet the conversion condition.

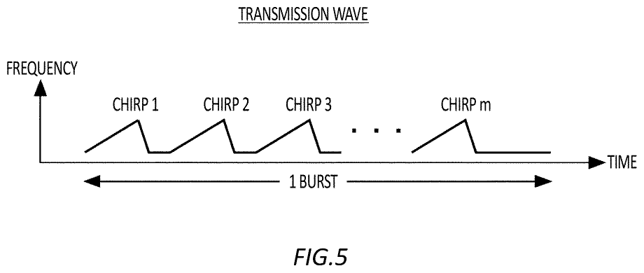

FIG. 5 is a diagram illustrating one example of a transmission wave emitted by the transmission unit 120. In the present example, the measurement device 100 is a radar device of the FMCW method but the measurement device 100 is not limited thereto. FIG. 5 illustrates a transmission wave emitted by one transmission antenna. The transmission unit 120 of the present example may repeatedly emit the transmission wave with a pattern referred to as burst. FIG. 5 illustrates one burst.

One burst of the transmission wave includes m chirp signals. m is an integer of 1 or more. One chirp signal is an electromagnetic wave in which the frequency is swept according to time. In the example in FIG. 5 each chirp signal includes a portion in which the frequency linearly increases according to time. The aspect of the change in the frequency may be the same or may be different among each chirp signal. The distance R to the target object 12, the velocity V of the target object 12, and the azimuth θ can be calculated by modulating the frequency of the chirp signal and analyzing the difference between the frequency of the emitted transmission wave and the frequency of the received reflected wave. The vibration corresponding to the sound produced by the target object 12 can be extracted based on the temporal variation in the distance R.

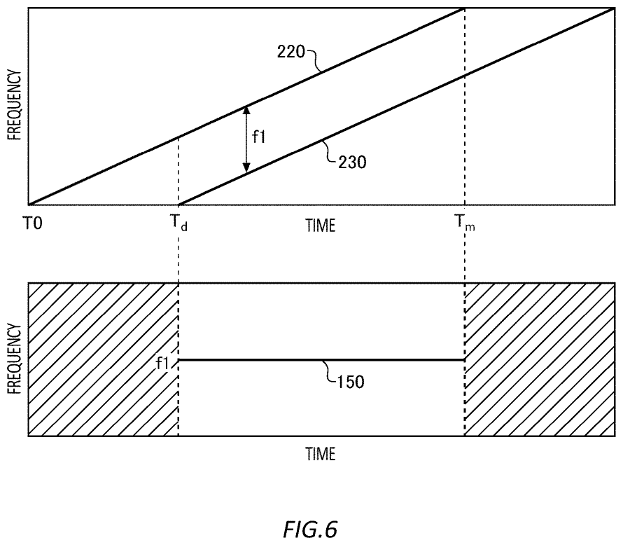

FIG. 6 is a diagram illustrating the transmission signal 220, the reception signal 230 obtained from the reflected wave, and the intermediate signal 150. The transmission signal 220 in FIG. 6 indicates the portion in one chirp signal in which the frequency increases according to time.

The frequency of the transmission signal 220 linearly increases during a period from time TO to time Tm. After a delay time Td elapses since the transmission signal 220 is transmitted, the reflected wave is received and the reception signal 230 is generated. The delay time Td changes according to the distance R from the measurement device 100 to the target object 12. In the minute periods Td-Tm when the transmission signal 220 is transmitted and the reception signal 230 is received simultaneously, the frequency difference f1 between the transmission signal 220 and the reception signal 230 is constant, assuming that the distance R is constant. Since the frequency difference f1 is determined by the delay time Td, the frequency difference f1 indicates the distance R to the target object 12.

The intermediate signal 150 is a signal having frequency f1, which is the difference between the frequency of the transmission signal 220 and the frequency of the reception signal 230. The intermediate signal generation unit 170 may generate the intermediate signal 150 based on the transmission signal 220 and the reception signal 230 in the periods Td to Tm. The data processing unit 30 of the present example performs FFT processing on the temporal waveform of the intermediate signal 150 and generates the frequency spectrum of the intermediate signal 150. The frequency f1 indicating the peak in the frequency spectrum corresponds to the distance R to the target object 12.

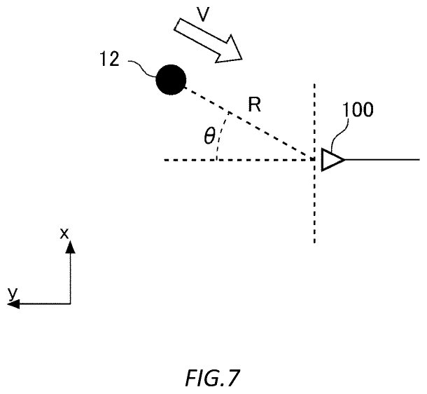

FIG. 7 is a diagram illustrating the distance R, the velocity V, and the azimuth θ of the target object 12. For brevity, in the present example, it is assumed that the transmission unit 120 and the reception unit 140 of the measurement device 100 are at the same position.

The target object 12 varies at the velocity V at the position that is the distance R away from the measurement device 100. The velocity V is the relative velocity of the measurement device 100 and the target object 12. The azimuth θ is the angle of the target object 12 viewed from the measurement device 100. In one example, when it is assumed that the x-axis direction is defined as the direction in which a plurality of reception antennas of the reception unit 140 are arranged and the y-axis is defined as the direction in which the FMCW radar is emitted, the azimuth θ is the angle between the y-axis and the position of the target object 12 in the xy plane.

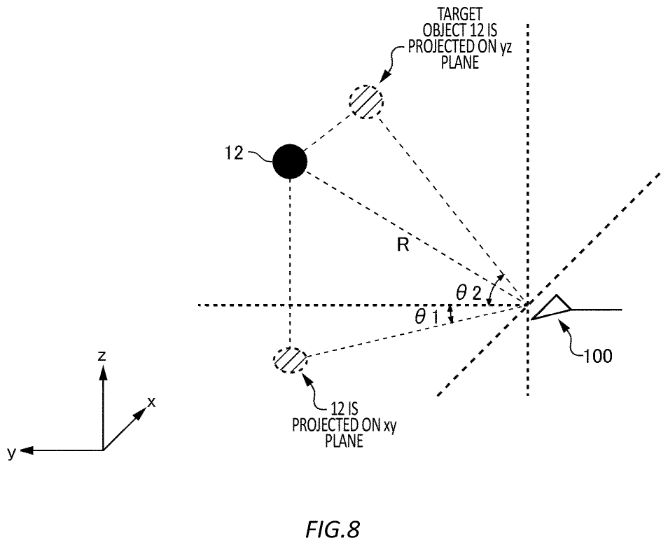

FIG. 8 is a diagram illustrating the distance R, the velocity V, the azimuth θ1, and the azimuth θ2 of the target object 12. In the present example, the position of the target object 12 in the xyz space is sensed. In the present example, a plurality of reception antennas may be arranged in both the x-axis direction and the z-axis direction. The information processing device 10 of the present example senses the azimuth θ1 obtained by projecting the target object 12 on the xy plane as well as the azimuth θ2 obtained by projecting the target object 12 on the yz plane. In the present specification, when simply referring to “the azimuth”, it may include both the azimuth θ1 and the azimuth θ2.

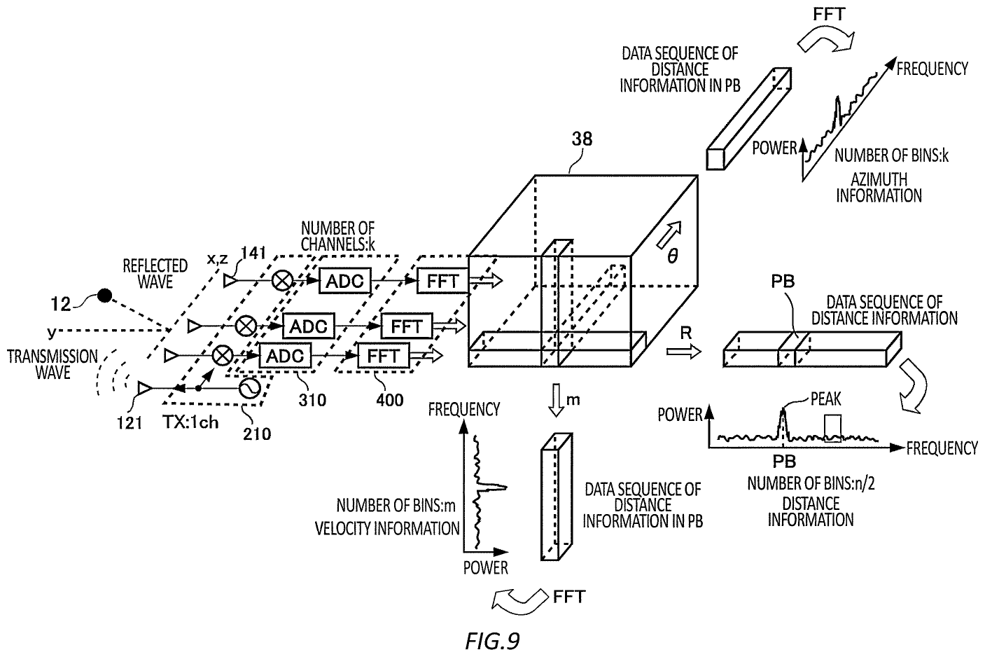

FIG. 9 is a diagram for describing the operating principle of a system 300. The system 300 acquires each information related to the distance R, the velocity V, and the azimuth θ of the target object 12 by using the data cube 38.

The measurement device 100 has a plurality of transmission and reception channels. Each transmission and reception channel is a combination of the transmission antenna and the reception antenna. In one example, the measurement device 100 has one transmission antenna 121 and k reception antennas 141. k is an integer of 1 or more. The measurement device 100 may have a plurality of transmission antennas 121. Although FIG. 9 illustrates a plurality of reception antenna 141 arranged in a row, the reception antenna 141 may be disposed to be arranged along both the x-axis and the z-axis. The measurement device 100 can detect the azimuth θ by having a plurality of transmission and reception channels. Each of the reflected waves from the target object 12 is input to the k reception antennas.

The measurement data of the present example includes a plurality of intermediate signals corresponding to a plurality of transmission and reception channels (a plurality of reception antennas 141 in the present example). In addition, the measurement data includes the intermediate signal for each chirp signal. The data cube 38 is a three-dimensional data sequence in which the data sequence of the distance information generated from each intermediate signal is arranged by each transmission and reception channel and by each chirp signal number m. The intermediate signal for each transmission and reception channel includes the information related to the azimuth θ. In the data cube 38 in FIG. 9. the direction in which the intermediate signal for each transmission and reception channel is arranged is indicated with θ. In the present specification, the direction in which the transmission and reception channel is arranged in the data cube 38 is sometimes referred to as the azimuth direction. Each distance information corresponds to the distance R to the target object 12. The azimuth of the target object 12 relative to the measurement device 100 is obtained by performing FFT on the data of a predetermined bin number of the distance information in the azimuth direction. The velocity of the target object 12 is obtained by performing FFT on the data of a predetermined bin number of the distance information in the direction of the chirp signal number m.

The distance information generation unit 32 generates the distance information for each intermediate signal corresponding to each transmission and reception channel (the reception antenna 141 in the present example). The distance information generation unit 32 in the present example generates the distance information by performing the FFT processing on the digital data of the temporal waveform of the intermediate signal. The distance information of the present example is the power spectrum of the intermediate signal. In the present example, it is assumed that the number of bins of the distance information is n/2. In each distance information, the bin where the vertex of the peak exists is referred to as the peak bin PB. The distance information includes the peak bin PB according to the distance to the target object 12. In addition, the distance information generation unit 32 of the present example generates the distance information for each chirp signal.

The azimuth information generation unit 34 performs the angular FFT on the data sequence of the distance information corresponding to the position of the peak bin PB of the distance information and generates the azimuth information. The azimuth information is the power spectrum of the distance information in the peak bin PB. In the present example, it is assumed that the number of bins of the azimuth information is k. The angular FFT is the process of performing FFT in the azimuth direction on the value of each distance information at the position of the peak bin PB. The FFT in the azimuth direction is the process of arranging, in a sequence, the intermediate signals of the reception antennas disposed to be arranged in, for example, the x-axis or z-axis direction and performing the FFT in the sequence. The angular FFT may be performed in both the x-axis direction and the z-axis direction. The azimuth information generation unit 34 may generate the azimuth information of the x-axis direction from the distance information corresponding to the reception antennas arranged in the x-axis direction among the distance information corresponding to each transmission and reception channel and generate the azimuth information of the z-axis direction from the distance information corresponding to the reception antenna arranged in the z-axis direction.

The position of the peak bin PB indicates the value of the frequency of the intermediate signal. The azimuth information generation unit 34 may use the average value of the position of the peak bin PB in the plurality of pieces of distance information and may use the position of the peak bin PB in the distance information corresponding to a particular transmission and reception channel and a particular chirp signal. As one example, the azimuth information generation unit 34 may use the position of the peak bin PB of the distance information corresponding to the reception antenna disposed at the center among the plurality of reception antennas arranged along the x-axis and the z-axis.

The velocity information generation unit 36 performs Doppler FFT on the data sequence of the distance information at the position of the peak bin PB and generates the velocity information. The velocity information is a power spectrum of the distance information in the peak bin PB. In the present example, it is assumed that the number of bins of the velocity information is m. The Doppler FFT is a process of performing FFT in the time direction (in the present example, the direction of the chirp signal number m in the data cube 38) on the value of each distance information at the position of the peak bin PB.

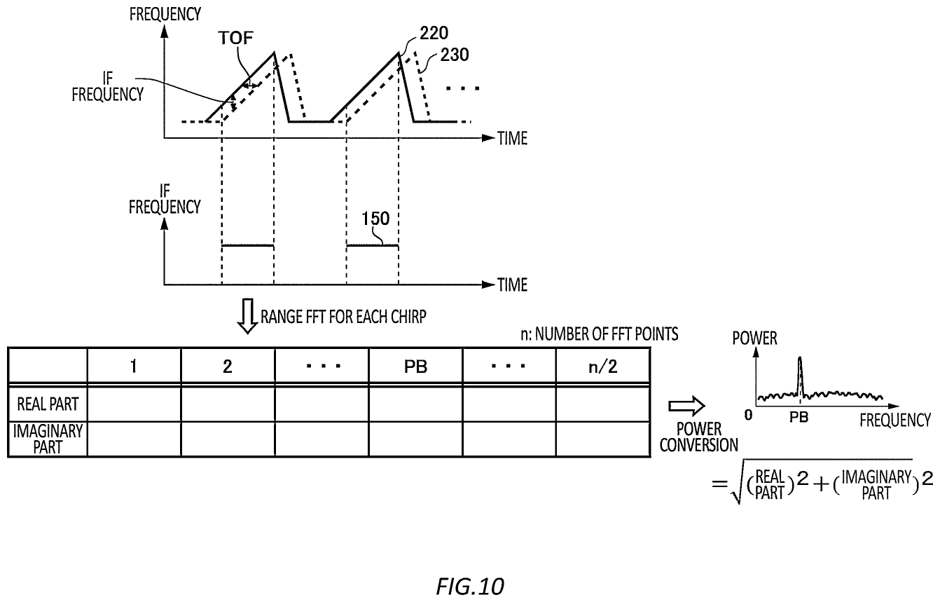

FIG. 10 is a diagram illustrating the principle for sensing the distance R to the target object 12. The distance R to the target object 12 is calculated by the range FFT on the intermediate signal corresponding to at least one of the chirp signals. FIG. 10 illustrates the reception signal 230 obtained from the transmission signal 220 and the reflected wave corresponding to one transmission and reception channel. The solid line of the graph indicates the transmission signal 220 and the dashed line indicates the reception signal 230. A vertical axis represents a frequency and a horizontal axis represents a time.

The IF frequency is the frequency of the intermediate signal 150 obtained by mixing the transmission signal 220 and the reception signal 230. The IF frequency increases as the distance R between the measurement device 100 and the target object 12 increases. The information processing device 10 can acquire the distance R to the target object 12 by analyzing the IF frequency.

The information processing device 10 performs the range FFT processing for each chirp signal and generates the distance information. For example, when the number of FFT points is n points, data sequences of both a real part and an imaginary part are obtained by n/2 points, and the number of bins is n/2. The information processing device 10 calculates the peak bin PB by acquiring the distance power spectrum from the result of the range FFT. The information processing device 10 may generate the distance information for each intermediate signal. The information processing device 10 can calculate the distance R to the target object 12 based on the frequency of the peak bin PB.

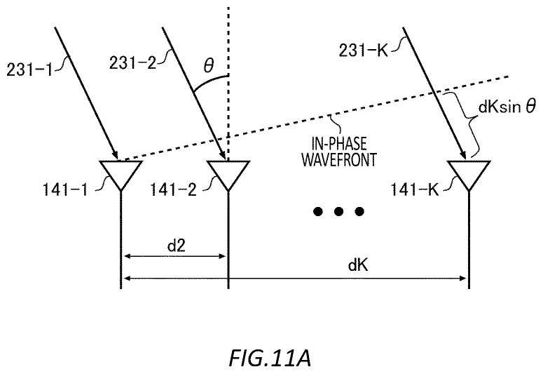

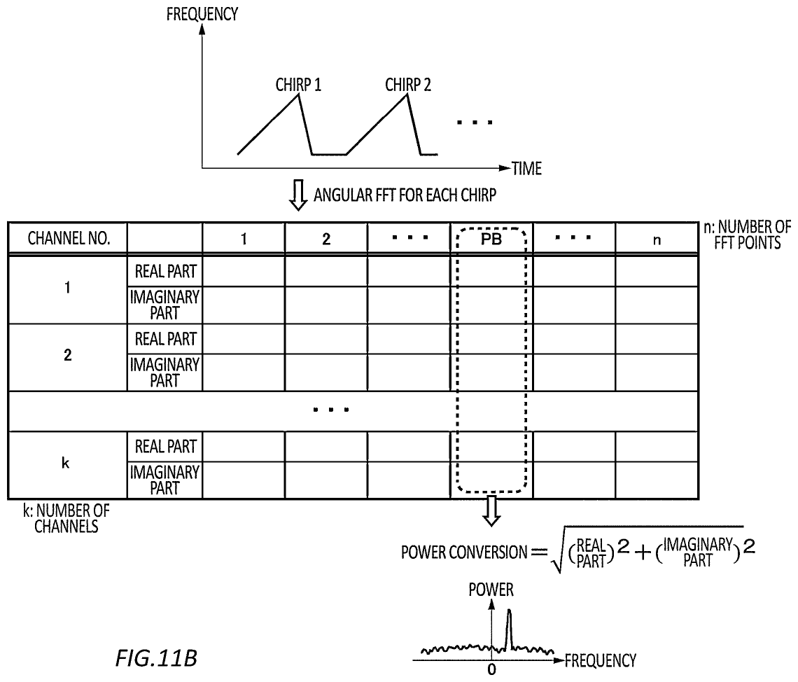

FIG. 11A is a diagram illustrating the principle for sensing the azimuth θ of the target object 12. The information processing device 10 of the present example detects the azimuth θ of the target object 12 based on the K reflected waves 231-1 to 231-K received by K reception antennas 141-1 to 141-K. The distance between the reception antenna 141-1 and the reception antenna 141-x is referred to as dx (x is an integer of 2 to K).

If the distance between the reception antennas 141 is sufficiently small relative to the distance to the target object 12, the angles θ with which the reflected waves 231 from the target object 12 enter the respective reception antennas 141 are approximately the same. On the other hand, the phases of the reflected waves 231 received by respective reception antennas 141 are different according to the positions of the reception antennas 141. For example, the position of the reflected wave 231-K that is in-phase with the reflected wave 231-1 received by the reception antenna 141-1 is separated from the reception antenna 141-K by dK sin θ in the direction of the azimuth θ. In this way, the timings at which the in-phase wavefronts of the reflected waves 231 reach the respective reception antennas 141 are determined by the position of the reception antenna 141 and the azimuth θ.

The information processing device 10 can calculate the azimuth θ based on the position of each reception antenna 141 and the phase of the reflected wave 231 received by each reception antenna 141. The position of each reception antenna 141 is a fixed value. The information related to the position of each reception antenna 141 is incorporated in advance into the arithmetic process of the information processing device 10. The information processing device 10 of the present example calculates the azimuth θ based on the phase of the reflected wave 231 received by each reception antenna 141.

The information processing device 10 may calculate the azimuth θ from the phase of the reflected wave 231 by using the angular FFT, Capon method, LP method (linear prediction method), MUSIC method, ESPRIT method, compressed sensing method, or the like. In the present example, the example in which the azimuth θ is calculated by the angular FFT is described.

FIG. 11B is a diagram illustrating a process of sensing the azimuth θ of the target object 12 by the angular FFT. The table in FIG. 11B indicates the real part and imaginary part of the distance information obtained by the range FFT for each transmission and reception channel (for example, the combination of the transmission antenna 121 and the reception antenna 141) of the measurement device 100. The azimuth information generation unit 34 extracts the data of the peak bin PB in the distance information of each transmission and reception channel. In FIG. 11B, the data of the peak bin PB is surrounded by dotted lines.

The azimuth information generation unit 34 performs the angular FFT on the data sequence of each distance information obtained by the range FFT performed on the chirp signal of each transmission and reception channel. The angular FFT is the process of performing the FFT in the direction of the transmission and reception channel on the value of each distance information in the peak bin PB. In the present example, there is one transmission antenna 121 and the number of the transmission and reception channels is equal to the number of the reception antennas 141. The transmission and reception channel number indicates the position in the arrangement axis of each reception antenna 141. In other words, when the transmission and reception channel numbers are adjacent to each other, the corresponding reception antennas 141 are disposed to be adjacent to each other in the arrangement axis. In the present example, it is assumed that the number of the reception antennas 141 and the transmission and reception channels arranged in the x-axis direction is k. The measurement data includes k intermediate signals according to the k transmission and reception channels for calculating the azimuth θ in the x-axis direction for one chirp signal.

The information processing device 10 performs the angular FFT processing for the k transmission and reception channels when the azimuth θ in the x-axis direction is detected. In the case of k transmission and reception channels, k points of the data sequence of the real part and the imaginary part are each obtained and the number of bins is k. In the reflected waves 231 received by respective reception antennas 141, a phase difference occurs according to the azimuth θ of the target object 12 relative to the reception antenna 141. The frequency of the variation in the phase of the intermediate signal between the adjacent transmission and reception channels can be detected by performing the angular FFT on the value of the distance information in the peak bin PB in the direction in which the reception antenna 141 is arranged (the transmission and reception channel direction). In the spectrum obtained by the angular FFT, a peak appears at the bin position according to the azimuth θ in which the target object 12 exists. The azimuth θ of the target object 12 can be calculated from the position of the peak. Although the azimuth θ for the x-axis direction is described in the present example, the azimuth θ for the z-axis direction can also be calculated similarly.

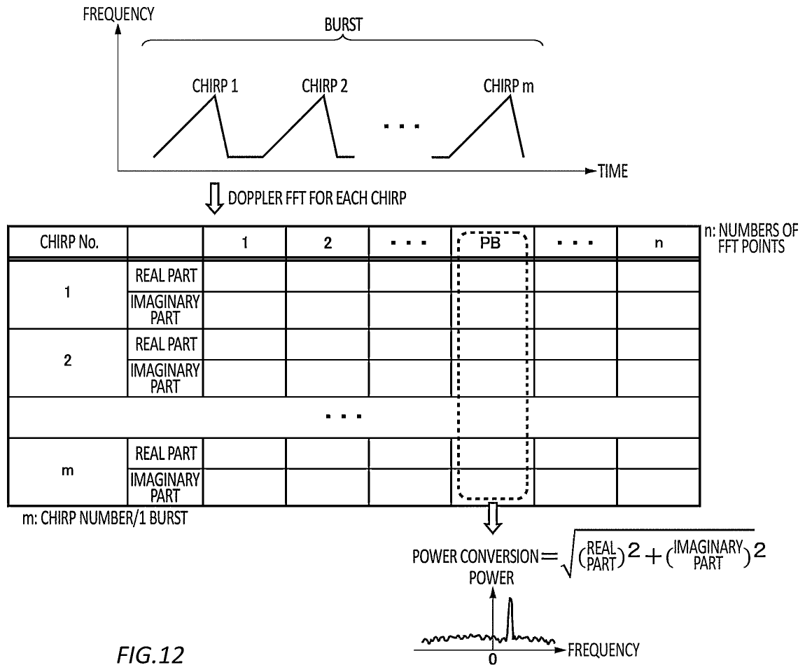

FIG. 12 is a diagram illustrating the principle for sensing the velocity V of the target object 12. The table in FIG. 12 illustrates the real part and imaginary part of the distance information obtained through the range FFT for each chirp signal 1-m in the burst. The velocity information generation unit 36 extracts the data of the peak bin PB in each distance information. In FIG. 12, the data of the peak bin PB is surrounded by the dotted line. The velocity information generation unit 36 performs the FFT (the Doppler FFT) on the extracted data sequence in the direction of the chirp signal number.

If the time interval between each chirp signal is sufficiently small, the distance to the target object 12 measured for each chirp signal shows little variation. Therefore, each distance information has a peak at the same peak bin PB. On the other hand, the phase of the intermediate signal changes due to a minute movement of the target object 12 in the time interval of the chirp signal. The frequency of the phase variation of the intermediate signal between the consecutive chirp signals can be detected by performing the Doppler FFT in the direction of the chirp signal number on the value of the distance information in the peak bin PB. In the velocity power spectrum obtained by the Doppler FFT, a peak appears at the bin position according to the frequency of the phase variation. The velocity V of the target object 12 can be calculated from the position of the peak.

The minute movement of the target object 12 can be detected based on the variation in the time direction in the phase of the intermediate signal indicated in the distance information. The phase of the intermediate signal can be calculated from the arctangent of the ratio of the real part to the imaginary part of the distance information. The chirp number corresponds to the elapsed time. The velocity information generation unit 36 may acquire the temporal waveform data of the minute shift of the target object 12 by arranging the value of the phase of the intermediate signal in the peak bin PB according to the chirp number. The temporal waveform of the minute shift of the target object 12 corresponds the the temporal waveform of the sound of the measurement target.

In the present example, for the distance information corresponding to each chirp signal, the Doppler FFT and the acquisition of the temporal waveform of the minute shift are performed with the peak bin PB being constant. However, since the distance R to the target object 12 significantly varies when the target object 12 wholly or partially moves, the peak bin PB of the distance information corresponding to each chirp signal sometimes varies.

The velocity information generation unit 36 may detect the peak bin PB for each distance information corresponding to each chirp signal. If a predetermined reference number or more pieces of the distance information in which the position of the peak bin PB does not change are detected in the direction of the chirp signal number, the velocity information generation unit 36 may acquire the temporal waveform of the minute shift of the target object 12 from these distance information. If a predetermined reference number or more of the distance information in which the position of the peak bin PB does not change are detected in the direction of the chirp signal number, the velocity information generation unit 36 may perform the Doppler FFT on these distance information and generate the velocity power spectrum of the target object 12.

The velocity information generation unit 36 may also perform the Doppler FFT and the acquisition of the temporal waveform of the minute shift in the target object 12 by using the position of the common peak bin PB even if the position of the individual peak bin PB of each distance information changes. The position of the common peak bin PB may be the position of the peak bin PB that appears most frequently in each distance information, for example. The phase is sometimes not continuous between the distance information in which the positions of the individual peak bin PB are different. The velocity information generation unit 36 may correct the phase of each intermediate signal so that the continuity of the phase increases. As disclosed in Patent Document 2, the velocity information generation unit 36 may correct the phase based on the position of the individual peak bin PB.

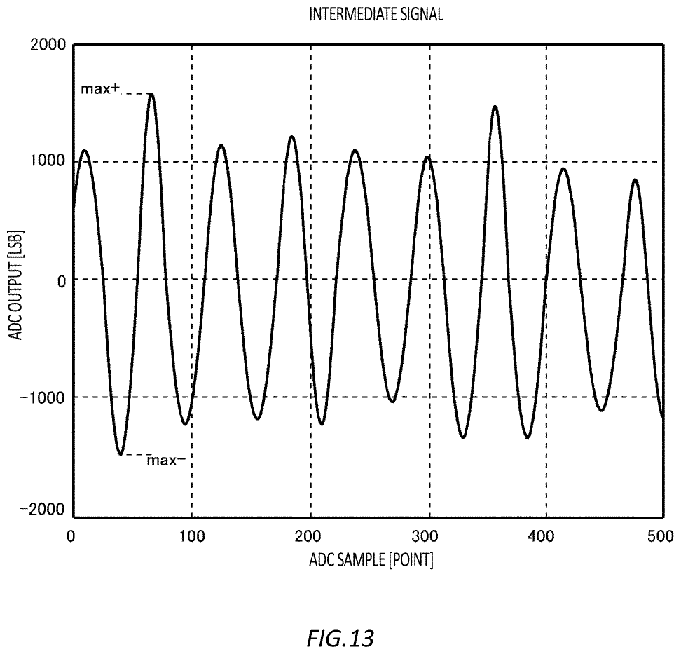

FIG. 13 is a diagram illustrating one example of the temporal waveform of the intermediate signal converted into the digital signal. FIG. 13 illustrates the temporal waveform of the intermediate signal corresponding to one chirp signal. The conversion condition determination unit 40 detects the maximum amplitude of the intermediate signal. The maximum amplitude may be the maximum amplitude on the positive side (max+), may be the maximum amplitude on the negative side (max−), may be the maximum amplitude on the positive side or the maximum amplitude on the negative side, whichever has a larger absolute value, or may be the difference between the maximum amplitude on the positive side and the maximum amplitude on the negative side.

### (Determination Process 1)

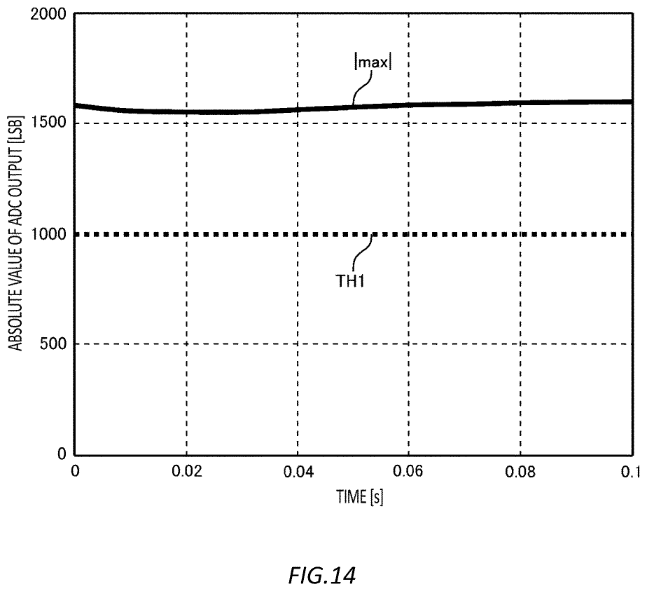

FIG. 14 is a diagram illustrating one example of the operation of the conversion condition determination unit 40. In the present specification, the determination process using the amplitude in the intermediate signal described in FIG. 14 is sometimes referred to as a determination process 1. FIG. 14 illustrates the time series data of the absolute value |max| of the maximum amplitude in the intermediate signal. The conversion condition determination unit 40 may detect the absolute value of the maximum amplitude in the intermediate signal corresponding to a plurality of chirp signals and use it as the time series data.

The conversion condition determination unit 40 may determine whether the conversion condition is met based on the measurement data. The conversion condition determination unit 40 of the present example determines whether the conversion condition is met based on the amplitude of the reflected wave indicated in the measurement data. The amplitude of the intermediate signal is determined according to the amplitude of the reflected wave. The conversion condition determination unit 40 of the present example indirectly determines whether the amplitude of the reflected wave meets a predetermined condition by determining whether the amplitude of the intermediate signal meets a predetermined condition.

The conversion condition determination unit 40 of the present example determines that the intermediate signal meets the conversion condition if the absolute value |max| of the maximum amplitude of the intermediate signal is higher than the predetermined determination threshold TH1. The conversion condition determination unit 40 may determine that the intermediate signal meets the conversion condition if the absolute value |max| of the maximum amplitude of the intermediate signal is continuously higher than the determination threshold TH1 for a predetermined determination period. The predetermined determination period is a period in which a plurality of chirp signals are included. The determination period may be a period in which a chirp signal corresponding to one burst is included.

If the target object 12 is too far from the measurement device 100, it is relatively difficult to measure a minute shift due to the production of sound. Since the amplitude of the reflected wave is attenuated according to the distance between the target object 12 and the measurement device 100, it can be determined whether the appropriate sound data can be acquired by determining the conversion condition based on the amplitude of the reflected wave. The conversion condition determination unit 40 may adjust the determination threshold TH1 based on the amplitude of the transmission wave to be transmitted by the transmission unit 120. For example, the conversion condition determination unit 40 increases the determination threshold TH1 as the amplitude of the transmission wave increases.

The conversion condition determination unit 40 may adjust the threshold TH1 according to the attribute of the target object 12. The attribute of the target object 12 may include at least one of identity identification information such as a name to identify the identity of the target object 12, gender identification information to identify the gender of the target object 12, age identification information to identify the age of the target object 12, size information to indicate the size such as a height of the target object 12, and classification information to indicate the classification of the target object 12 as the organism. The conversion condition determination unit 40 may have the threshold TH1 that is set in advance for each attribute of the target object 12. The conversion condition determination unit 40 may determine the attribute of the target object 12 based on the image of the target object 12. The measurement device 100 may include a capturing unit to acquire the image of the target object 12. The conversion condition determination unit 40 may adjust the threshold of the threshold TH1 according to the azimuth information described below. The conversion condition determination unit 40 may have the preset information indicating the relationship between the azimuth information and the threshold TH1.

The conversion condition determination unit 40 may stop the data processing in the data processing unit 30 and the data conversion unit 50 until the amplitude of the reflected wave meets the conversion condition. The amplitude of the reflected wave can be acquired without the processing in the data processing unit 30. Therefore, by determining the conversion condition based on the amplitude of the reflected wave, the electric power consumption in the data processing unit 30 and the data conversion unit 50 can be suppressed.

The conversion condition determination unit 40 may also determine that the conversion condition is not met if the target object 12 is too close to the measurement device 100. The conversion condition determination unit 40 may determine that the intermediate signal meets the conversion condition if the absolute value of the maximum amplitude of the intermediate signal is within a predetermined range for determination. The conversion condition determination unit 40 may adjust at least one of the upper limit value or the lower limit value of the range for determination based on the amplitude of the transmission wave to be transmitted by the transmission unit 120.

If there is an object other than the target object 12 in the space toward which the transmission wave is emitted, the measurement device 100 detects the reflected wave from the object. Thus, if the conversion condition is determined based on the amplitude of the reflected wave, the conversion condition is sometimes wrongly determined by mistaking the object for the target object 12. If the amplitude of the reflected wave meets the conversion condition, the conversion condition determination unit 40 may cause at least a part of the data processing in the data processing unit 30 and the data conversion unit 50 to be performed and further determine whether the processing result meets the conversion condition. For example, after the intermediate signal is converted into sound data, the conversion condition determination unit 40 may determine whether the sound data meets the predetermined condition.

If the sound data does not meet the predetermined condition, the information processing device 10 may determine that sound data cannot be appropriately acquired in the current reflected wave. The information processing device 10 may record the amplitude value of the reflected wave when it is determined that the data processing results in the data processing unit 30 and the data conversion unit 50 do not meet the predetermined condition. The information processing device 10 may stop the data processing in the data processing unit 30 and the data conversion unit 50 until the variation in the amplitude value of the newly measured reflected wave relative to the recorded amplitude value is equal to or more than a predetermined reference value. Such processing can prevent the reflected wave from an object that is not the measurement target such as a chair from being converted into the sound data.

### (Determination Process 2)

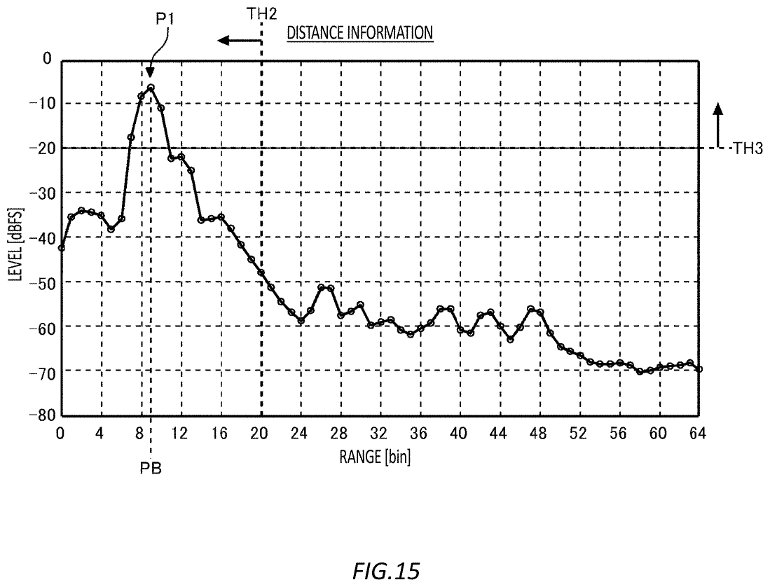

FIG. 15 is a diagram illustrating another example of the operation of the conversion condition determination unit 40. In the present specification, the determination process using the distance information described in FIG. 15 is sometimes referred to as a determination process 2. FIG. 15 illustrates the spectrum of the distance information corresponding to a predetermined chirp signal and transmission and reception channel. The distance information generation unit 32 of the data processing unit 30 illustrated in FIG. 4 generates the distance information.

The conversion condition determination unit 40 of the present example determines whether the distance information meets the conversion condition. The conversion condition determination unit 40 may further perform the determination process 2 if the amplitude of the reflected wave meets a predetermined condition in the determination process 1 described in FIG. 14. In another example, the conversion condition determination unit 40 may perform the determination process 2 without performing the determination process 1.

The conversion condition determination unit 40 may perform the determination process 2 for one or more transmission and reception channels. For example, the determination process 2 may be performed for the distance information corresponding to the reception antenna disposed at the center. If the distance information meets the conversion condition, it may be determined that the distance information of all the transmission and reception channels meets the conversion condition. The conversion condition determination unit 40 may perform the determination process 2 on the spectrum in which a plurality of pieces of distance information corresponding to a plurality of transmission and reception channels are overlaid. The conversion condition determination unit 40 may perform the determination process 2 on the spectrum generated by performing coherent integral on the distance information in the azimuth direction.

The conversion condition determination unit 40 may remove the noise or clutter components included in the distance information and then perform each determination process. The clutter component is a reflected component from an object other than the target object 12, for example.

The transmission signal 220 of the present example includes a chirp signal in which the frequency gradually changes, as illustrated in FIG. 5 and FIG. 6. The measurement data includes the intermediate signal 150 having the frequency according to the difference between the frequency of the reception signal 230 and the frequency of the transmission signal 220. The data processing unit 30 performs Fourier transform (FFT in the present example) on the intermediate signal 150 to generate the distance information. The distance information is a frequency spectrum in which the horizontal axis indicates ranges and the vertical axis indicates levels. The range indicates the bin of the FFT and corresponds to the frequency of the intermediate signal 150.

The conversion condition determination unit 40 determines whether at least one of the magnitude of the peak P1 of the distance information or the position of the peak bin PB (the bin in the present example) meets the conversion condition. The peak P1 is a point having the highest level in the distance information. The peak bin PB is the bin where the peak P 1 exists. The position of the peak bin PB corresponds to the distance R from the measurement device 100 to the target object 12. In the present example, the value of the position of the peak bin PB increases as the distance R increases.

The conversion condition determination unit 40 may determine that the position of the peak bin PB meets the conversion condition if the position of the peak bin PB is equal to or less than a predetermined threshold TH2. If the distance R is too high, it is relatively difficult to precisely detect a minute shift of the target object 12.

The conversion condition determination unit 40 may determine that the magnitude of the peak P1 meets the conversion condition if the magnitude of the peak P1 is equal to or more than a predetermined threshold TH3. If the peak P1 is too small, the ratio of the component of the sound of the measurement target to the noise component (S/N ratio) becomes small.

The conversion condition determination unit 40 may determine whether the number of peaks in which the level is equal to or more than the predetermined threshold TH3 meets a predetermined conversion condition. For example, the conversion condition determination unit 40 may determine that the conversion condition is not met if two or more of the peaks exist in one distance information.

The conversion condition determination unit 40 may determine whether the half width of the peak P1 meets a predetermined conversion condition. For example, the conversion condition determination unit 40 may determine that the conversion condition is not met if the half width of the peak P1 is equal to or more than a predetermined threshold.

The conversion condition determination unit 40 may adjust at least one threshold such as the threshold TH2 and the threshold TH3 according to the attribute of the target object 12. The conversion condition determination unit 40 may have each threshold that is preset for each attribute of the target object 12. The conversion condition determination unit 40 may adjust at least one of the thresholds such as the threshold TH2 and the threshold TH3 according to the azimuth information described below. The conversion condition determination unit 40 may have the preset information to indicate the relationship between the azimuth information and the threshold such as the threshold TH2 and the threshold TH3.

### (Determination Process 3)

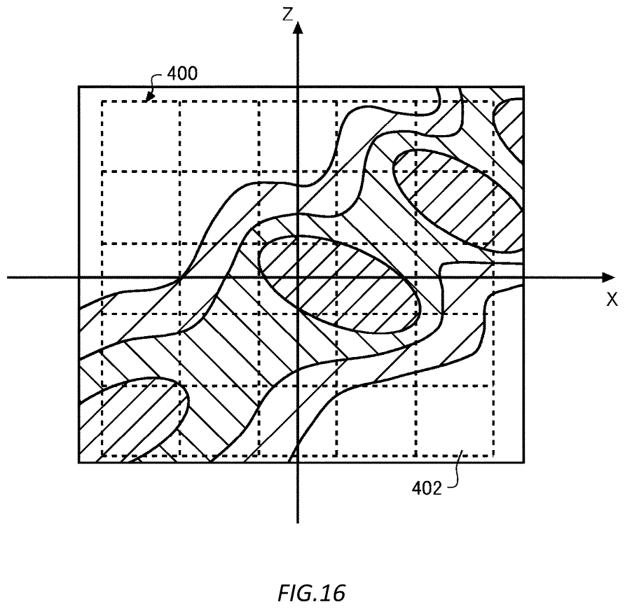

FIG. 16 is a diagram illustrating one example of the azimuth information. The azimuth information generation unit 34 illustrated in FIG. 4 generates the azimuth information. As described in FIG. 11B, the azimuth information generation unit 34 may perform the FFT in the azimuth direction on the distance information of the peak bin PB to generate the azimuth information. The azimuth information generation unit 34 in the present example generates the azimuth information in both the x-axis direction and the z-axis direction. FIG. 16 schematically illustrates the azimuth information of the x-axis direction and the z-axis direction on the orthogonal axes. In FIG. 16, as the level of the azimuth information increases, the displayed density of hatching increases. In addition, in FIG. 16, the measurement range 400 described in FIG. 2 is overlaid for display.

The graph in FIG. 16 indicates that the intermediate signal of the region 402 with a high level of the azimuth information is suitable for conversion of the sound data. The azimuth information generation unit 34 may determine whether the reflected wave in each azimuth (the intermediate signal in the present example) meets the conversion condition based on the azimuth information. If the level of the azimuth information is equal to or more than the predetermined threshold, the azimuth information generation unit 34 may determine that the intermediate signal of the region 402 meets the conversion condition. The conversion condition determination unit 40 may also adjust the threshold according to the attribute of the target object 12. The conversion condition determination unit 40 may have the threshold that is preset for each attribute of the target object 12.

In the present specification, the determination process using the azimuth information, described in FIG. 16, is sometimes referred to as a determination process 3. The conversion condition determination unit 40 may perform the determination process 3 after performing at least one of the determination process 1 or the determination process 2. The conversion condition determination unit 40 may perform the determination process 3 if it determines that the conversion condition is met for all the performed determination processes among the determination process 1 and the determination process 2.

### (Determination Process 4)

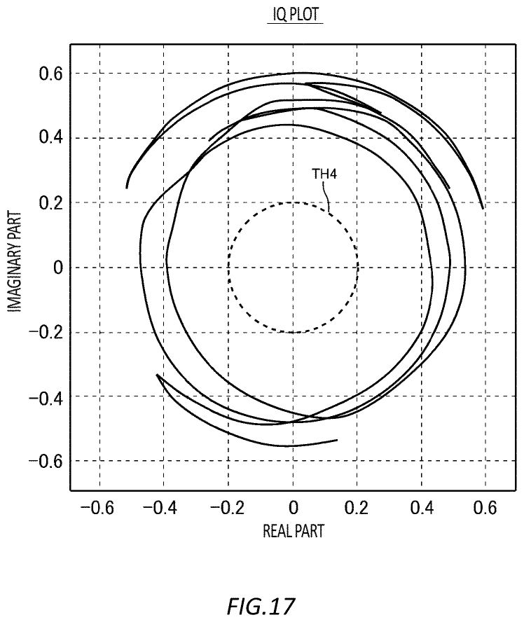

FIG. 17 is a diagram illustrating one example of an IQ plot in a peak bin PB of the intermediate signal. In the present specification, the determination process using an IQ plot, described in FIG. 17, is sometimes referred to as a determination process 4. In FIG. 17, the temporal change in the real part I and the imaginary part Q of the distance information of the peak bin PB are plotted on the orthogonal axes. If the phase of the intermediate signal of the peak bin PB corresponds to the appropriate sound data, the IQ plot in FIG. 17 exhibits a circular shape or an arc shape with a predetermined radius or more.

In the determination process 3 described in FIG. 16, the conversion condition determination unit 40 may generate the IQ plot for the intermediate signal of each region 402 in which the azimuth information is determined to meet the conversion condition. The conversion condition determination unit 40 may determine whether the IQ plot of the intermediate signal exhibits a circular shape or an arc shape whose radius is equal to or more than the threshold TH4. If the IQ plot meets the condition, the conversion condition determination unit 40 may determine that the intermediate signal meets the conversion condition. The conversion condition determination unit 40 may also adjust the threshold TH4 according to the attribute of the target object 12. The conversion condition determination unit 40 may have the threshold that is preset for each attribute of the target object 12.

### (Determination Process 5)

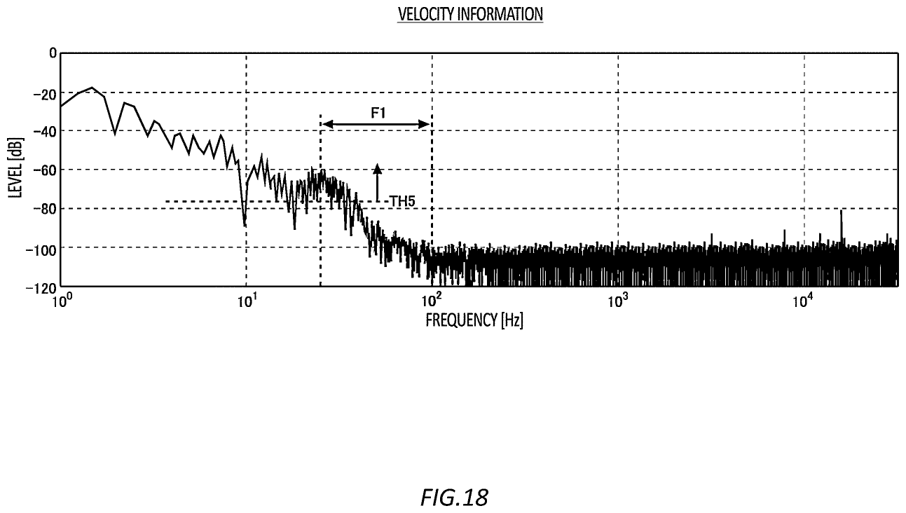

FIG. 18 is a diagram illustrating one example of the velocity information. As described in FIG. 12, the velocity information generation unit 36 performs the FFT in the direction of the chirp signal number (that is, the time direction) on the phase of the intermediate signal in the peak bin PB to generate the velocity information. The velocity information is the frequency spectrum of the phase variation of the intermediate signal. The velocity information generation unit 36 of the present example may generate the velocity information for the region 402 (that is, the azimuth e) determined to meet the conversion condition in the determination process 3.

The level of the frequency component in the velocity information corresponds to the level of the frequency component of the sound data. The conversion condition determination unit 40 determines whether the measurement data meets the conversion condition based on the velocity information. In the present specification, the determination process using the velocity information, described in FIG. 18, is sometimes referred to as a determination process 5.

The conversion condition determination unit 40 of the present example may determine whether the conversion condition is met based on a predetermined component of the frequency band F1 in the velocity information. The frequency band F1 is a band corresponding to the sound of the measurement target. If the heart sound is to be measured, the frequency band F1 may be equal to or more than 30 Hz and equal to or less than 100 Hz.

If there is a component equal to or more than the predetermined threshold TH5 in the frequency band F1, the conversion condition determination unit 40 may determine that the measurement data meets the conversion condition. Thus, the sound data in which the frequency component of the sound of the measurement target is too small can be excluded. The conversion condition determination unit 40 may adjust the threshold TH5 according to the attribute of the target object 12. The conversion condition determination unit 40 may have the threshold that is preset for each attribute of the target object 12.

The conversion condition determination unit 40 may perform one of the determination process 4 and the determination process 5 on the intermediate signal of the region 402 extracted by the determination process 3. The conversion condition determination unit 40 may perform both the determination process 4 and the determination process 5 on the intermediate signal of the region 402 extracted by the determination process 3. In this case, if it is determined that the conversion condition is met in the processes of at least one of the determination process 4 or the determination process 5, it may be determined that the intermediate signal meets the conversion condition, or, if it is determined that the conversion condition is met in both the determination process 4 and the determination process 5, it may be determined that the intermediate signal meets the conversion condition.

The data conversion unit 50 converts the intermediate signal determined to meet the conversion condition into the sound data in the determination process including at least one of the determination process 1 to the determination process 5. The data conversion unit 50 may combine one or more processes from the determination process 1 to the determination process 5 to extract the intermediate signal to be converted into the sound data. The data conversion unit 50 may convert the intermediate signal determined to meet the conversion condition in all the processes from the determination process 1 to the determination process 5 into the sound data.

### (Determination Process 6)

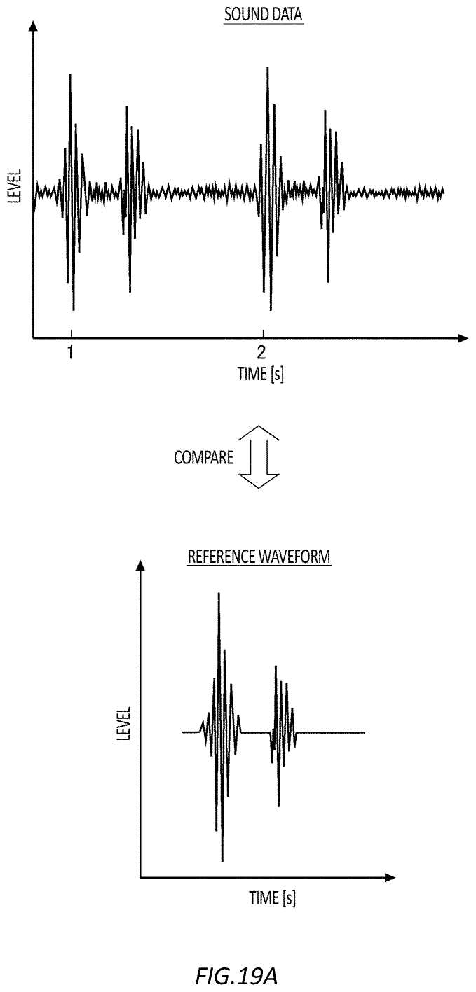

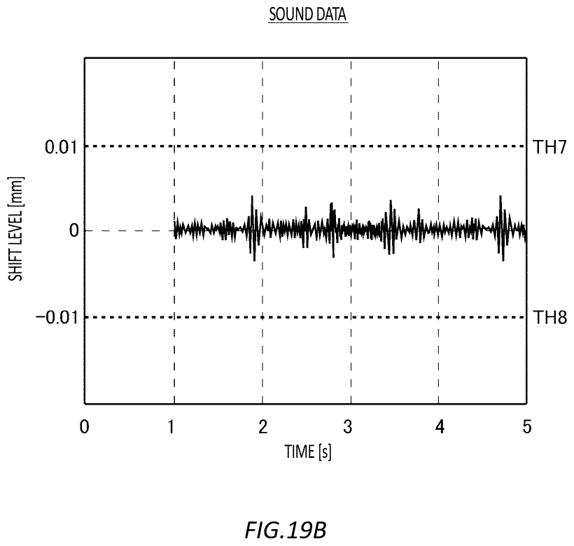

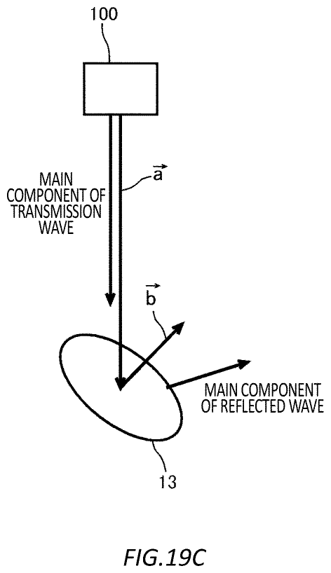

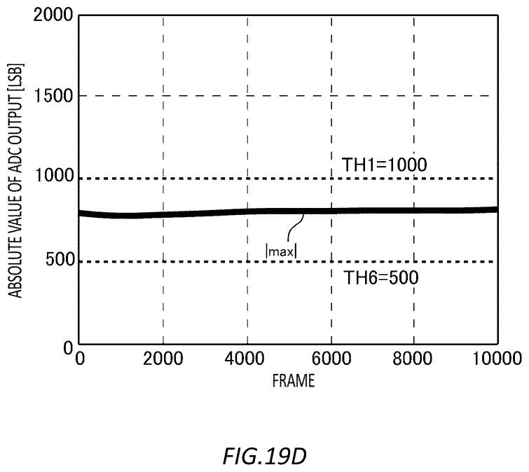

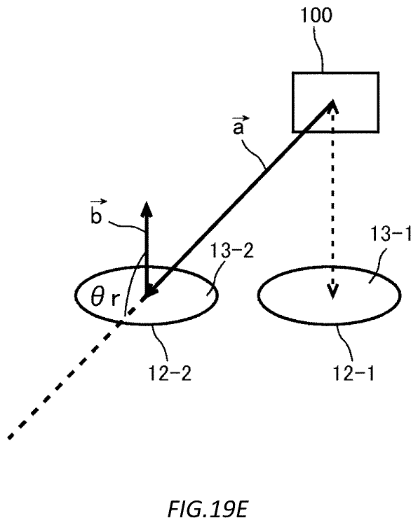

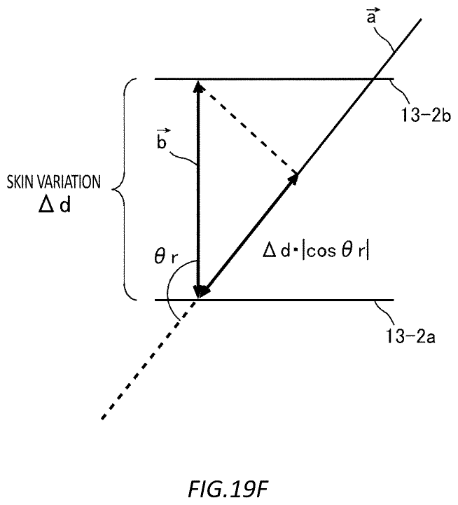

FIG. 19A is a diagram illustrating one example of the sound data converted from the measurement data. The measurement target of the present example is a heart sound. The data conversion unit 50 of the present example extracts the temporal waveform of the phase value of the intermediate signal in the peak bin PB as the sound data. The data conversion unit 50 may plot the data of the phase value of the intermediate signal in the direction of the chirp signal number to generate the waveform of the sound data.

The conversion condition determination unit 40 of the present example compares the temporal waveform indicated in sound data converted by the data conversion unit 50 to the predetermined reference waveform and determines whether the sound data meets the conversion condition. The conversion condition determination unit 40 may calculate the similarity between the reference waveform and the temporal waveform of the sound data and determine that the sound data meets the conversion condition if the similarity is equal to or more than the threshold. The calculated similarity increases as the parameters, such as the interval between the peaks of the temporal waveform, the ratio of the magnitude of each peak, the half width of each peak, for example, are closer to each other. In addition, various pattern matching may be performed using a Pearson correlation coefficient or the like.

The conversion condition determination unit 40 records the sound data meeting the conversion condition as the sound data to be provided to a user and processes the sound data not meeting the conversion condition as the sound data not to be provided to the user. In the present specification, the process using the temporal waveform of the sound data is sometimes referred to as a determination process 6.

The conversion condition determination unit 40 may extract the component of the predetermined frequency band in the sound data converted from the measurement data and compare it to the reference waveform. The frequency band corresponds to the band of the sound of the measurement target. The conversion condition determination unit 40 may compare the waveform obtained by removing the high-frequency noise equal to or more than a predetermined frequency in the sound data to the reference waveform.

### (Determination Process 7)

FIG. 19B is a diagram illustrating one example of the sound data converted from the measurement data. The measurement target of the present example is a heart sound. The data conversion unit 50 of the present example extracts the temporal waveform of the phase value of the intermediate signal in the peak bin PB as the sound data. The data conversion unit 50 may plot the data of the phase value of the intermediate signal in the direction of the chirp signal number to generate the waveform of the sound data.

The conversion condition determination unit 40 of the present example determines whether the conversion condition is met using the amplitude of the temporal waveform indicated in the sound data converted by the data conversion unit 50. In the present specification, the determination process using the amplitude of the temporal waveform indicated in the sound data, described in FIG. 19B, is sometimes referred to as a determination process 7.

If the amplitude of the sound data crosses at least any of the predetermined determination thresholds TH7 or TH8, the conversion condition determination unit 40 of the present example determines that the conversion condition is met. In FIG. 19B, the positive threshold of the shift level corresponding to the sound data is referred to as TH7 and the negative threshold is referred to as TH8. In the present specification, crossing a threshold refers to being higher than a positive threshold or being lower than a negative threshold. The conversion condition determination unit 40 may extract the component of the predetermined frequency band in the sound data converted from the measurement data and determine the amplitude of the temporal waveform.

### (Determination Process 8)

In the determination processes 1 to 7, the conversion condition determination unit 40 determines whether the information included in the measurement data meets the conversion condition. In another example, the conversion condition determination unit 40 may further determine whether the relative azimuth of the measurement device 100 and the target object 12 meets the predetermined conversion condition. Thus, the sound data of the target object 12 can be acquired more efficiently.

FIG. 19C and FIG. 19D are diagrams illustrating another example of the operation of the conversion condition determination unit 40. In the present specification, the determination process using the amplitude in the intermediate signal and the distance information, described in FIG. 19C and FIG. 19D, is sometimes referred to as a determination process 8.

FIG. 19C is a diagram illustrating the effect of the relative azimuth of the target object 12 and the measurement device 100 on the amplitude of the reflected wave. As one example, it is assumed that the target object 12 is a person, its representative plane 13 is the frontal plane of the body, and its normal vector b is defined in the forward direction of the body of the sagittal horizontal axis. In addition, as one example, it is assumed that the direction vector a from the measurement device 100 to the target object 12 is the vector with its start point at the center of gravity of the measurement device 100 and its end point at the center of gravity of the target object 12. In this case, according to the posture of the human as the target object 12 relative to the measurement device 100, the relative azimuth of the measurement device 100 and the target object 12 changes and the intensity of the reflected wave received by the measurement device 100 also changes.

The conversion condition determination unit 40 of the present example may use the amplitude in the intermediate signal to preliminarily determine whether to determine the distance information. If the amplitude in the intermediate signal meets the predetermined condition, the conversion condition determination unit 40 may perform the determination of the distance information in the determination process 2. The conversion condition determination unit 40 may determine whether the relative azimuth of the measurement device 100 and the target object 12 meets the conversion condition based on the amplitude in the intermediate signal and the distance information.

The conversion condition determination unit 40 of the present example may also perform the determination using the amplitude in the intermediate signal and the determination of the distance information with the same period. This determination period may be longer than the measurement period for acquiring the sound data that meets the conversion condition. Thus, the electric power consumption can be reduced. The conversion condition determination unit 40 may perform at least a part of the determination process using the amplitude in the intermediate signal and at least a part of the determination process of the distance information in parallel.

FIG. 19D illustrates the time series data of the absolute value |max| of the maximum amplitude in the intermediate signal, like FIG. 14. The frame of the process in the horizontal axis of FIG. 19D corresponds to the time in the horizontal axis of FIG. 14. The conversion condition determination unit 40 may detect the absolute value of the maximum amplitude in the intermediate signal corresponding to a plurality of chirp signals and use it as the time series data. The conversion condition determination unit 40 of the present example may determine whether the preliminary conversion condition to perform the determination of the distance information is met based on the amplitude of the reflected wave indicated in the measurement data. The amplitude of the intermediate signal is determined according to the amplitude of the reflected wave. The conversion condition determination unit 40 of the present example indirectly determines whether the amplitude of the reflected wave meets a predetermined condition by determining whether the amplitude of the intermediate signal meets a predetermined condition. In the present specification, the determination process using the amplitude in the intermediate signal, described in FIG. 19D, is sometimes referred to as a determination process 8-1.

The conversion condition determination unit 40 of the present example may determine that the intermediate signal meets the preliminary conversion condition and perform the determination of the distance information if the absolute value |max| of the maximum amplitude of the intermediate signal is higher than the predetermined determination threshold TH6. The conversion condition determination unit 40 may determine that the intermediate signal meets the preliminary conversion condition if the absolute value |max| of the maximum amplitude of the intermediate signal is continuously higher than the determination threshold TH6 for a predetermined determination period. The predetermined determination period is a period in which a plurality of chirp signals are included. The determination period may be a period in which a chirp signal corresponding to one burst is included.

Similar to the determination process 1, the conversion condition determination unit 40 of the present example may determine that the intermediate signal meets the conversion condition if the absolute value |max| of the maximum amplitude of the intermediate signal is higher than the predetermined determination threshold TH1. The conversion condition determination unit 40 may determine that the intermediate signal meets the conversion condition if the absolute value |max| of the maximum amplitude of the intermediate signal is continuously higher than the determination threshold TH1 for a predetermined determination period. The predetermined determination period is a period in which a plurality of chirp signals are included. The determination period may be a period in which a chirp signal corresponding to one burst is included.

The determination threshold TH6 may be set to a smaller value than the determination threshold TH1. Thus, the determination threshold 6 can prevent the signal processing when the target object 12 is not in the vicinity of the information processing device 10 and also avoid the situation in which the measurement cannot be performed efficiently due to an unsuitable relative azimuth even though the target object 12 is near the information processing device 10.

The conversion condition determination unit 40 of the present example determines whether the distance information meets the conversion condition through the determination process 2 if the amplitude of the reflected wave meets the preliminary conversion condition. The conversion condition determination unit 40 may determine that the relative azimuth of the target object 12 and the measurement device 100 is inappropriate if the position of the peak bin PB is equal to or less than the predetermined threshold TH2 and the absolute value |max| of the maximum amplitude of the intermediate signal is smaller than the predetermined determination threshold TH1.

The conversion condition determination unit 40 may determine that the relative azimuth of the target object 12 and the measurement device 100 is inappropriate if the magnitude of the peak P1 is equal to or more than the predetermined threshold TH3, the position of the peak bin PB is equal to or less than the predetermined threshold TH2, and the absolute value |max| of the maximum amplitude of the intermediate signal is smaller than the predetermined determination threshold TH1. If the peak P1 is too small, the ratio of the component of the sound of the measurement target to the noise component (S/N ratio) becomes small.

The conversion condition determination unit 40 may adjust at least one of the thresholds such as the threshold TH1 or the threshold TH6 according to the attribute of the target object 12. The conversion condition determination unit 40 may have each threshold that is preset for each attribute of the target object 12. The conversion condition determination unit 40 may adjust at least one of the thresholds such as the threshold TH1 or the threshold TH6 according to the azimuth information described below. The conversion condition determination unit 40 may have the preset information to indicate the relationship between the azimuth information and the threshold such as the threshold TH1 and the threshold TH6.

### (Determination Process 9)

In the determination process 8, the relative azimuth of the measurement device 100 and the target object 12 is determined based on the amplitude in the intermediate signal and the distance information. The present example shows a determination process using the amplitude in the intermediate signal, the distance information, and the phase variation amount. Thus, since the relative azimuth of the measurement device 100 and the target object 12 can be more accurately determined, the sound data of the target object 12 can be acquired more efficiently.

FIG. 19E is a diagram illustrating the effect of the relative azimuth Or of the target object 12 and the measurement device 100 on the phase variation amount. As one example, it is assumed that the target object 12 is a person, its representative plane 13 is the frontal plane of the body, and its normal vector b is defined in the forward direction of the body of the sagittal horizontal axis. In addition, as one example, it is assumed that the direction vector a from the measurement device 100 to the target object 12 is the vector with its start point at the center of gravity of the measurement device 100 and its end point at the center of gravity of the target object 12. In this case, according to the posture of the human as the target object 12 relative to the measurement device 100, the relative azimuth Or of the measurement device 100 and the target object 12 changes and the phase variation amount received by the measurement device 100 also changes.

FIG. 19E illustrates the target objects 12-1 and 12-2 at two positions whose relative azimuths to the measurement device 100 are different. As described above, the relative azimuth θr is the angle θr between the normal vector b of the representative plane 13 and the direction vector a from the measurement device 100 to the target object 12. In the example of FIG. 19E, the relative azimuth θr of the target object 12-1 is 180 degrees.

FIG. 19F illustrates an example in which the position of the representative plane 13 of the target object 12-2 varies in the direction of a normal vector b. For example, the representative plane 13-2 is the skin of the target object 12-2 and the skin moves from the position of the representative plane 13-2a to the position of the representative plane 13-2b due to the breathing or the like of the target object 12-2. For example, Δd is defined as the amplitude of the vibration in the case where the direction of the normal vector b on the representative plane 13 of the target object 12 matches the direction of vibration corresponding to the sound to be measured. In this case, the observable vibration component is Δd·| cos (θr)| according to the normal vector b defining the relative azimuth θr and the angle θr of the direction vector a from the target object 12 to the measurement device 100. If the relative azimuth θr is 180 degrees as in the target object 12-1 illustrated in FIG. 19E, the observable vibration component is Δd. On the other hand, as illustrated in FIG. 19F, if θr is not 0 degrees or 180 degrees, the observable vibration component corresponding to | cos (θr)| decreases.

Therefore, even if the target object 12 is at the distance sufficiently close to the measurement device 100 and the conversion condition of the amplitude of the reflected wave and the distance information is met in the determination process 1 and the determination process 2, appropriate sound data may not be obtained depending on the relative azimuth θr to the measurement device 100 due to the orientation or posture of the target object 12. In other words, the conversion condition determination unit 40 can determine whether the relative azimuth of the target object 12 and the measurement device 100 is appropriate according to at least one of the amplitude of the reflected wave or the distance information and the phase shift information, which is the information of the phase variation amount of the intermediate signal.

In the present specification, the determination process related to the relative azimuth using the amplitude in this intermediate signal, the distance information, and the phase variation amount is sometimes referred to as a determination process 9. Specifically, if the conversion condition of at least any of the determination process 1 or the determination process 2 is met and the conversion condition of at least any of the determination process 4, the determination process 5, or the determination process 7 is not met, the conversion condition determination unit 40 may determine that the relative azimuth of the target object 12 and the measurement device 100 is inappropriate.

In the determination process 8 or 9, the data processing unit 30 may calculate the relative azimuth determination information with the target object 12 based on at least one of the amplitude of the reflected wave, the distance information, or the phase shift information. The phase shift information is the information indicating the phase variation of the intermediate signal. The relative azimuth determination information is the indicator to determine whether the relative azimuth meets the predetermined conversion condition. The relative azimuth determination information may not be the information directly indicating the magnitude of the relative azimuth. For example, the relative azimuth determination information may include at least one of the amplitude of the reflected wave, the distance information, or the phase shift information. As described in the determination process 8 or 9, the conversion condition determination unit 40 may determine whether at least one of the amplitude of the reflected wave in the relative azimuth determination information, the distance information, or the phase shift information meets the conversion conditions. In another example, the relative azimuth determination information may be the information indicating the magnitude of the relative azimuth θr.

### (Determination Process 10)

In the determination processes 1 to 9, the conversion condition determination unit 40 determines whether the information included in the measurement data meets the conversion condition and whether the relative azimuth is appropriate. In another example, the conversion condition determination unit 40 may determine whether the conversion condition is met based on the image of the space to which the transmission wave is emitted. In the present specification, the process based on the image of the space is sometimes referred to as a determination process 10. If the target object 12 is included at the predetermined position in the image, the conversion condition determination unit 40 may determine that the conversion condition is met. The measurement device 100 may include an imaging device for acquiring the image. The imaging device may acquire the image continuously over time or periodically.

The conversion condition determination unit 40 may calculate the distance R from the measurement device 100 to the target object 12 based on the image. If the calculated distance R meets the predetermined condition, the conversion condition determination unit 40 may determine that the conversion condition is met.

The conversion condition determination unit 40 may calculate the posture or orientation of the target object 12 based on the image. The conversion condition determination unit 40 may determine whether the posture or orientation of the target object 12 meets the conversion condition. For example, if the chest of the target object 12 points in the direction of the measurement device 100, the conversion condition determination unit 40 may determine that the conversion condition is met.

The conversion condition determination unit 40 may perform the determination process 10 in addition to the determination process according to the measurement data. For example, if it is determined that the conversion condition is met in the determination process 10, the conversion condition determination unit 40 may perform the determination process according to the measurement data. The conversion condition determination unit 40 may perform the determination process 10 instead of any of the determination processes 1 to 6. For example, the conversion condition determination unit 40 may perform the determination process 10 instead of the determination process 1.

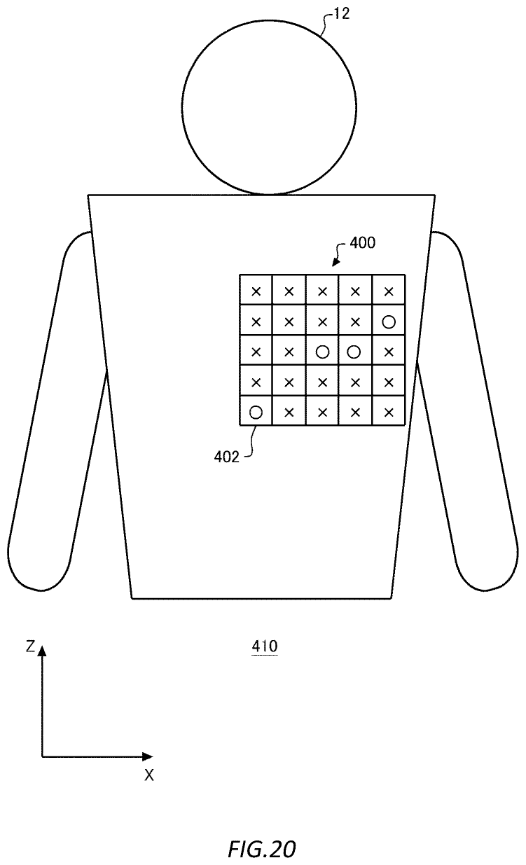

FIG. 20 is a diagram illustrating one example of data map 410 generated by a conversion condition determination unit 40. The data map 410 indicates whether the sound data to be provided to the user exists for each azimuth θ. The data map 410 of the present example includes the information indicating whether the sound data to be provided to the user exists for each of a plurality of regions 402 included in the measurement range 400. The plurality of regions 402 correspond to a plurality of azimuths θ.

The conversion condition determination unit 40 may generate the information for displaying the data map 410. The data map 410 may include the information indicating the positions of the plurality of regions 402 and the information for displaying whether the sound data exists for each region 402 (the circle symbols and the cross symbols in FIG. 20). The conversion condition determination unit 40 may generate the information for overlaying the image indicating the plurality of regions 402 and the image indicating at least a part of the target object 12 for display. The image of the target object 12 may be an image in which the target object 12 itself is captured or may be a schematic image indicating at least a part of the target object 12. The conversion condition determination unit 40 may generate the data map 410 including the sound data corresponding to each region 402. If a circle symbol of the region 402 is selected on the image displayed by the display device, the conversion condition determination unit 40 may generate the data map 410 so that the corresponding sound data is played.

The data map 410 may include the information indicating the priority of the sound data of each region 402. For example, the conversion condition determination unit 40 may give a higher priority to the sound data corresponding to a higher amplitude of the reflected wave. The conversion condition determination unit 40 may give a higher priority to the sound data corresponding to a higher level of the frequency component in the frequency band of the sound of the measurement target. The data map 410 may include numerical values indicating the priority of the sound data in addition to or instead of the circle symbols in FIG. 20.

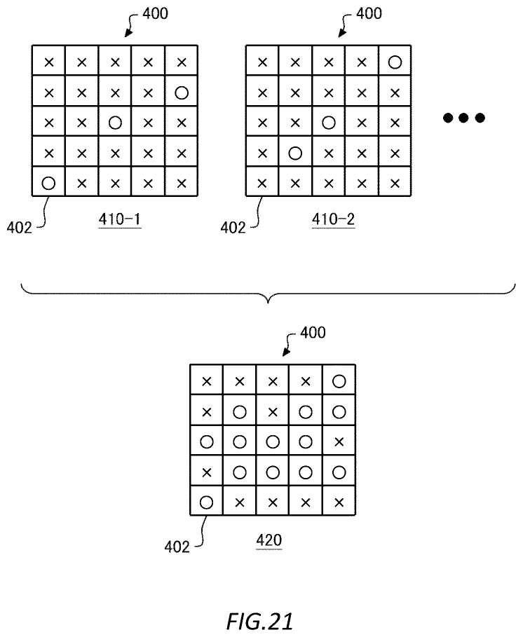

FIG. 21 is a diagram illustrating one example of a combined data map 420 generated by the conversion condition determination unit 40. The conversion condition determination unit 40 of the present example generates the data map 410 for each of the different timings. For example, the conversion condition determination unit 40 generates the data map 410 for each burst of the transmission signal 220.

The conversion condition determination unit 40 generates the combined data map 420 indicating whether the sound data exists in at least one of the timings based on the generated plurality of data maps 410. For example, for each region 402, the conversion condition determination unit 40 determines whether the sound data to be provided to the user exists in at least one data map 410. The conversion condition determination unit 40 of the present example also marks, with circle symbols, the region 402 in the combined data map 420 which is marked with a circle symbol in at least one data map 410. Thus, the number of the regions 402 where the sound data that can be provided to the user exists can be increased. If a plurality of sound data that can be provided to the user exist in one region 402, the conversion condition determination unit 40 may record the sound data with the highest priority in association with the region 402. In addition, in the plurality of data map 410, the region 402 in which it is determined that the sound data repeatedly exists may be displayed as a region with a high degree of confidence of measurement by using the change in the color or numerical values. This degree of confidence may be displayed in combination with the priority in the conversion condition determination unit 40 (the numerical value is added or multiplied) or may be separately displayed.

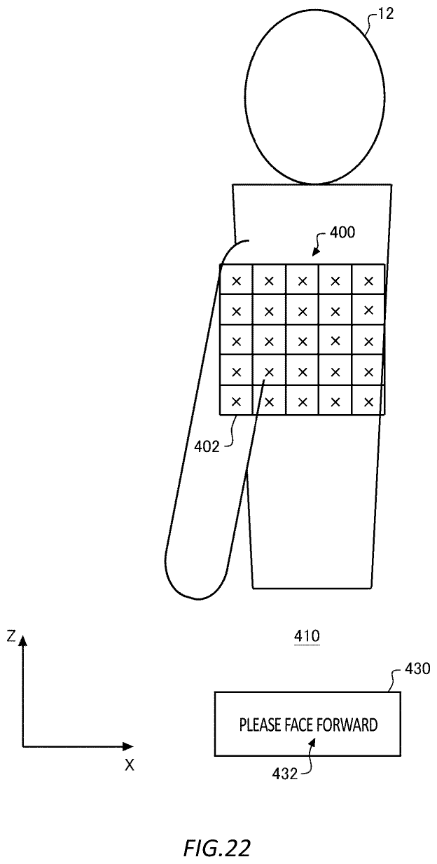

FIG. 22 is a diagram illustrating another example of the data map 410 generated by the conversion condition determination unit 40. In the present example, the sound data that can be provided to the user does not exist in all the regions 402. In other words, the measurement data of the present example does not meet the conversion condition.

If the measurement data does not meet the conversion condition, the conversion condition determination unit 40 of the present example generates the notification information notifying that the conversion condition is not met. If the measurement data does not meet the conversion condition and it is determined that the relative azimuth (or the relative azimuth determination information) of the target object 12 and the measurement device 100 is inappropriate in at least one of the determination process 8 or 9, the conversion condition determination unit 40 of the present example generates the notification information notifying that the relative azimuth is inappropriate.

If the measurement data does not meet the conversion condition, the conversion condition determination unit 40 of the present example generates the indication information 432 indicating the position to which the target object 12 should move to meet the conversion condition. The position of the target object 12 includes the posture of the target object 12, and the relative position and the relative azimuth of the target object 12 and the measurement device 100. The conversion condition determination unit 40 may determine the current position of the target object 12 based on the image of the target object 12. The conversion condition determination unit 40 may indicate the position to which the target object 12 should move and the posture it should assume according to the current position of the target object 12. For example, if the target object 12 is facing sideways with respect to the measurement device 100, the conversion condition determination unit 40 may generate the indication information 432 indicating to face forward to the target object 12. The notification information and the indication information 432 may be displayed on the display device 430 or may be output via a voice. If the indication method for the user is a voice, the position to appropriately move can be indicated even when the user is measuring its back side. The display device 430 may be connected to the measurement device 100 or may be another information apparatus such as a smartphone, a smartwatch, or the like. For the indication method for the user, vibration, blink of an LED or the like, display on a screen, or sound localization may be used. For the notification via vibration, the intensity of vibration may be increased (or reduced) according to the distance of the target object from the position appropriate for measurement. For the blink of the LED or the like, the lighting interval may be changed according to the distance of the target object 12 from the position appropriate for measurement, or the way of lighting such as the lighting interval of the LED may be changed according to the relative position of the target object 12 in front, back, left, and right with respect to the measurement device 100, the orientation of the target object 12, or the posture of the target object 12. The way of lighting may include, for example, which of the plurality of LEDs should be lighted. For display on the screen, an arrow may be displayed. For display on the screen, the measurement position image indicating the position to which the target object 12 should move may be overlaid on the current position image indicating the current position of the target object 12 for display. For example, the current position image is the image of the target object 12. The measurement position image is, for example, the outline of at least a part of the target object 12.

The conversion condition determination unit 40 may generate the indication information 432 based on the distribution of the region 402 in which the sound data that can be provided exists. The conversion condition determination unit 40 may generate the indication information 432 indicating the position to which the target object 12 should move so that the region 402 in which the sound data that can be provided exists approaches the center of the measurement range 400. If a plurality of regions 402 exist, the conversion condition determination unit 40 may generate the indication information 432 indicating the position to which the target object 12 should move so that the center of the region in which regions 402 are distributed approaches the center of the measurement range 400.

The conversion condition determination unit 40 may generate the indication information 432 to search for the position meeting the conversion condition. For example, if there is a position meeting the conversion condition after the target object 12 is indicated to make full rotation and its relative azimuth is changed, it can be guided to the position meeting the conversion condition by indicating to make rotation in the opposite direction.

If the measurement data does not meet the conversion condition, the conversion condition determination unit 40 of the present example may move the position of the measurement device 100 to meet the conversion condition. The measurement device 100 may have a movable portion to change the relative position or relative azimuth with respect to the target object 12.

If the relative azimuth information in the relative position of the target object 12 does not meet the conversion condition, the conversion condition determination unit 40 may generate the indication information 432 indicating the position to which the target object 12 should move. If the relative azimuth information in the relative position of the target object 12 meets the conversion condition, the conversion condition determination unit 40 may convert at least a part of the measurement data into the sound data.

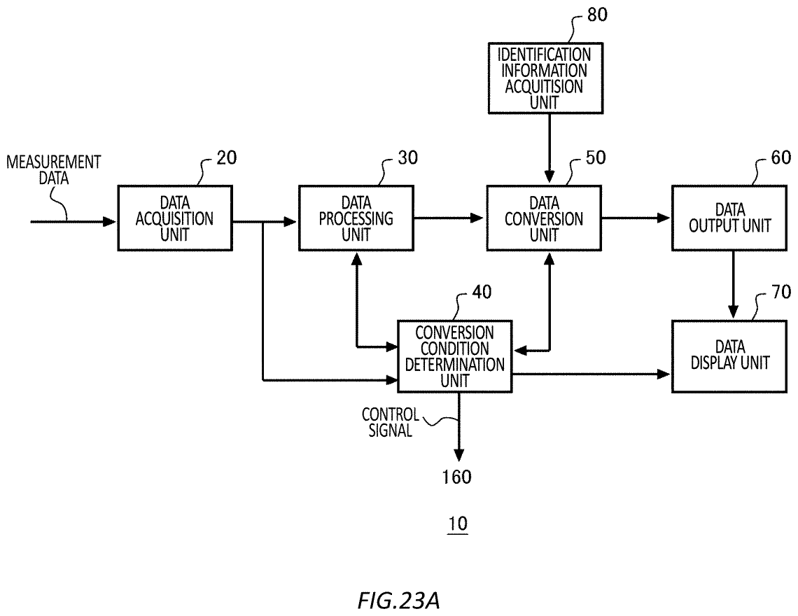

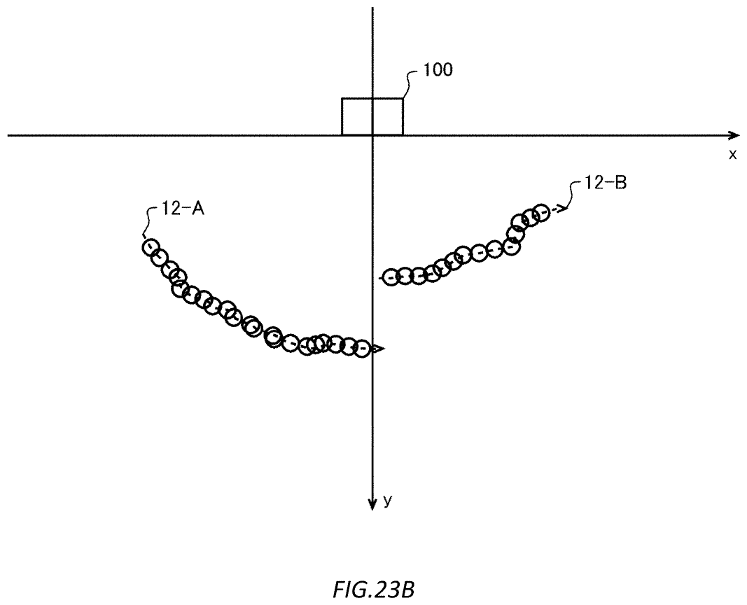

FIG. 23A is a block diagram illustrating another configuration example of the information processing device 10. The information processing device 10 of the present example further includes the identification information acquisition unit 80 in addition to the configuration of the information processing device 10 illustrated in FIG. 3. The identification information acquisition unit 80 acquires the identification information identifying the target object 12. The identification information is the information that allows the identity of the target object 12 to be distinguished. The data conversion unit 50 records the generated sound data and the identification information associated with each other. Thus, the automatically acquired sound data can be managed to indicate from which target object 12 it is acquired.

The identification information acquisition unit 80 may acquire the identification information related to the appearance of the target object 12 from the image of the target object 12. The identification information may include the information related to the face of the target object 12 or may include the information related to the magnitude of the target object 12 such as the height.

The identification information acquisition unit 80 may acquire the identification information related to the operation of the target object 12. The identification information may be acquired from the image of the target object 12 or may be acquired from the measurement data of the measurement device 100. The identification information may include the information related to the movement velocity of the target object 12. The identification information may include the information related to the movement velocity of the target object 12 approaching a predetermined object. The object is a mirror, for example. In addition, the object may be an electronic apparatus such as a smartphone, a tablet, a personal computer, a display, or a smart speaker, as well as office and residential equipment such as a door, a window, a wall, or a switch for a light or the like.

The identification information acquisition unit 80 may acquire the identification information indicating the sonogram of the target object 12. In this case, the measurement device 100 may include a voice acquisition unit for acquiring the voice data of the target object 12.

The identification information acquisition unit 80 may generate the identification information from the measurement data. The identification information acquisition unit 80 may compare the voice data which was previously generated and has been already associated with the identification information to newly generated voice data to determine which of the identification information the newly generated voice data corresponds to.

The identification information acquisition unit 80 may acquire the amplitude or period of the shift of the target object 12 generated from the measurement data as the identification information. For example, the amplitude and the period of the shift of the chest due to breathing vary among the identities of the target objects 12.

The identification information acquisition unit 80 may acquire the distance information and the azimuth information, generated from the measurement data, as the identification information. The relative position of the target object 12 from the measurement device 100 can be learned from the distance information and the azimuth information. From its temporal change and the trajectory of the relative position, the identity of the target object 12 can be identified. For example, the distance information is obtained by the range FFT, and the azimuth information is obtained by the angular FFT.

FIG. 23B is a diagram illustrating the temporal change of the relative position of the target object 12 obtained from distance information and azimuth information. In FIG. 23B, the position of the target object 12 is indicated with the plot of circle symbols by using any Cartesian coordinate system (the x-axis and the y-axis) with the measurement device 100 at the origin. In this case, the information processing device 10 can identify the identity of the target object 12 based on the continuity of the temporal change in the position. In the example in FIG. 23B, the plot of a plurality of circle symbols can be classified into a target object 12-A and a target object 12-B. In this case, the information processing device 10 may simultaneously indicate whether the measurement data acquired at the positions indicated with respective circle symbols meet the conversion condition. The target object 12 can be guided to a point that allows measurement for allowing efficient measurement by indicating whether the conversion condition is met along with the identification information.

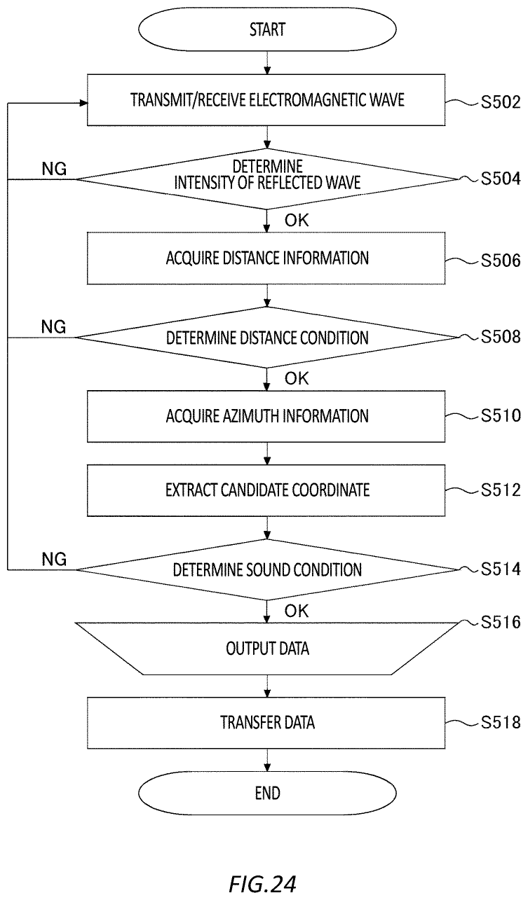

FIG. 24 is a flowchart illustrating one example of the operation of the system 300. The operation of the system 300 is not limited to the operation of the present example. The system 300 can perform the process described in the present specification.

In the measurement step S502, the measurement device 100 emits the transmission wave and receives the reflected wave 231. The measurement device 100 generates the measurement data based on the reflected wave 231.

In the reflected wave intensity determination step S504, the conversion condition determination unit 40 determines whether the intensity of the reflected wave 231 is higher than a predetermined threshold. The conversion condition determination unit 40 determines whether the absolute value |max| of the maximum amplitude of the intermediate signal 150 generated from the reflected wave 231 is higher than the threshold TH1, as in the determination process 1 described in FIG. 14. Thus, the intensity and the threshold of the reflected wave 231 can be indirectly compared. As in the determination process 8, the conversion condition determination unit 40 may set the threshold TH6 to preliminarily determine whether to perform the process described below, in addition to the threshold to determine the conversion condition. Thus, whether the relative azimuth of the target object 12 and the measurement device 100 is appropriate can be determined in combination with the result of the distance condition determination step S508 described below.

If the intensity of the reflected wave 231 is equal to or less than the threshold TH1, the conversion condition determination unit 40 determines that the conversion condition is not met. In this case, the system 300 repeats the process of S502. If the intensity of the reflected wave 231 is higher than the threshold, the conversion condition determination unit 40 determines that the conversion condition in the first step is met and performs the processes in S506 and onward.

If the intensity of the reflected wave 231 is equal to or less than the threshold TH6, the conversion condition determination unit 40 may not perform the subsequent processes. In this case, the system 300 repeats the process of S502. If the intensity of the reflected wave 231 is higher than the threshold TH6, the conversion condition determination unit 40 determines that the conversion condition of the first step is met and performs the processes in S506 and onward.

In the distance information acquisition step S506, the distance information generation unit 32 generates the distance information from the measurement data. The position of the peak bin PB in the distance information indicates the distance R from the measurement device 100 to the target object 12.

In the distance condition determination step S508, the conversion condition determination unit 40 determines whether the distance R to the target object 12 is within the predetermined range. The conversion condition determination unit 40 of the present example determines whether the position of the peak bin PB in the distance information is within the predetermined range, as in the determination process 2 described in FIG. 15. For the position of the peak bin PB, the average value of the position of the peak bin of the plurality of pieces of distance information may be used or the peak bin PB of the predetermined distance information such as the distance information corresponding to the region 402 disposed at the center of the measurement range may be used.

If the position of the peak bin PB is outside the predetermined range, the conversion condition determination unit 40 determines that the conversion condition is not met. In this case, the system 300 repeats the process of S502. The conversion condition determination unit 40 may determine that the conversion condition is met if the position of the peak bin PB is within the predetermined range. If the magnitude of the distance information in the peak bin PB is smaller than the predetermined threshold, the conversion condition determination unit 40 may determine that the conversion condition is not met. If both the position of the peak bin PB and the magnitude of the distance information in the peak bin PB meet the predetermined condition, the conversion condition determination unit 40 may determine that the conversion condition is met. If it is determined that the conversion condition is met, the information processing device 10 performs the processes in S510 and onward.

In the distance condition determination step S508, the conversion condition determination unit 40 may determine whether the relative azimuth of the target object 12 and the measurement device 100 is appropriate based on the reflected wave intensity determination result and the distance condition determination result. The conversion condition determination unit 40 determines whether the relative azimuth of the target object 12 and the measurement device 100 is appropriate by using the amplitude in the intermediate signal and the distance information, as in the determination process 8 described in FIG. 19C and FIG. 19D.

The conversion condition determination unit 40 may determine that the relative azimuth of the target object 12 and the measurement device 100 is inappropriate if the position of the peak bin PB is equal to or less than the predetermined threshold TH2 and the absolute value |max| of the maximum amplitude of the intermediate signal is smaller than the predetermined determination threshold TH1.

The conversion condition determination unit 40 may determine that the relative azimuth of the target object 12 and the measurement device 100 is inappropriate if the magnitude of the peak P2 is equal to or more than the predetermined threshold TH3, the position of the peak bin PB is equal to or less than the predetermined threshold TH2, and the absolute value |max| of the maximum amplitude of the intermediate signal is smaller than the predetermined determination threshold TH1.

In the azimuth information acquisition step S510, the azimuth information generation unit 34 acquires the azimuth information indicating the azimuth θ in which the intermediate signal to be converted into the sound data is received. The azimuth information generation unit 34 of the present example generates the azimuth information obtained by performing FFT in the azimuth direction on the complex data of the distance information in the peak bin PB.

In the candidate coordinate extraction step S512, the azimuth information generation unit 34 identifies the azimuth θ in which the intermediate signal to be converted into the sound data is received based on the azimuth information. As described in FIG. 16, the azimuth information generation unit 34 identifies the azimuth θ based on the position of the peak in the azimuth information. The azimuth information generation unit 34 may identify the coordinate in the X-Z plane of the region 402 corresponding to the azimuth θ. The azimuth information generation unit 34 extracts the sound data corresponding to the region 402 in which the peak of the azimuth information exists, as the candidate of the sound data to be provided to the user.

In the sound condition determination step S514, the conversion condition determination unit 40 determines whether each of the sound data extracted as the candidate meets the predetermined conversion condition. The conversion condition determination unit 40 may determine whether the IQ plot in which the phase in the peak bin PB is plotted is in a predetermined shape for each chirp signal as in the determination process 4 described in FIG. 17. If the shape of the IQ plot is a circle or an arc with a predetermined radius or more, the conversion condition determination unit 40 may determine that the sound data meets the conversion condition.

As in the determination process 5 described in FIG. 18, the conversion condition determination unit 40 may determine whether the velocity information obtained by performing FFT in the time direction on the complex data in the peak bin PB meets the predetermined conversion condition for each region 402 extracted in S512. As in the determination processes 6 and 7 described in FIG. 19A and FIG. 19B, the conversion condition determination unit 40 may determine whether the temporal waveform of the sound data is similar to the reference waveform or may determine whether the amplitude of the temporal waveform of the sound data crosses the predetermined threshold. The conversion condition determination unit 40 may perform at least one of the determination processes 4 to 9. If the conversion condition of at least any of the determination process 1 or the determination process 2 is met and the conversion condition of at least any of the determination process 4, the determination process 5, or the determination process 7 is not met, the conversion condition determination unit 40 may determine that the relative azimuth of the target object 12 and the measurement device 100 is inappropriate. The conversion condition determination unit 40 determines that the sound data of the region 402 meets the conversion condition if the condition is met in all the performed determination processes.

The data conversion unit 50 generates and records all the sound data meeting the conversion condition. The data conversion unit 50 may record each sound data and the coordinate of the region 402 associated with each other. The data conversion unit 50 may record the information indicating the time of measurement (for example, the combination of the burst number and the chirp signal number) in association with the sound data.

The conversion condition determination unit 40 causes the processes in S502 and onward to be repeated if it determines that all the candidates of the sound data extracted in S512 do not meet the conversion condition. It causes the processes in S516 and onward to be performed if at least one of the sound data meets the conversion condition.

In the data output step S516, the data output unit 60 outputs the sound data. The data output unit 60 may cause the data display unit 70 to display the information related to the sound data of the data map 410 or the like described in FIG. 20 or the like according to the indication from the user or the like. The data output unit 60 may play the sound corresponding to the sound data according to the indication from the user or the like.

In the data transfer step S518, the data output unit 60 transfers the sound data to an external device. The external device is, for example, a terminal of a doctor in a remote location. The data output unit 60 may transfer the data map 410 to the external device or may transfer information for generating the data map 410 to the external device. In the present example, the sound data not to be provided to the user among the sound data that can be generated from the measurement data received by the information processing device 10 is not transferred to the external device. Therefore, the amount of information transferred to the external device by the data output unit 60 can be smaller than the amount of information in the measurement data received by the information processing device 10.

Various embodiments of the present invention may be described with reference to flowcharts and block diagrams whose blocks may represent (1) steps of processes in which operations are performed or (2) sections of apparatuses responsible for performing operations. Certain stages and sections may be implemented by dedicated circuit, programmable circuit supplied together with computer readable instructions stored on computer readable media, and/or processors supplied together with computer readable instructions stored on computer readable media. Dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer readable medium may include any tangible device that can store instructions to be executed by a suitable device, and as a result, the computer readable medium having instructions stored thereon includes a product including instructions that can be executed in order to create means for executing operations designated in the flowcharts or block diagrams. Examples of the computer readable medium may include an electronic storage medium, a magnetic storage medium, an optical storage medium, an electromagnetic storage medium, a semiconductor storage medium, and the like. More specific examples of the computer readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray (registered trademark) disk, a memory stick, an integrated circuit card, or the like.

The computer readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk (registered trademark), JAVA (registered trademark), C++, or the like, and a conventional procedural programming language such as a “C” programming language or a similar programming language.

The computer readable instructions may be provided for a processor or programmable circuit of a general purpose computer, special purpose computer, or other programmable data processing apparatuses such as a computer locally or via a wide area network (WAN) such as a local area network (LAN), the Internet, or the like, and execute the computer readable instructions in order to create means for executing the operations designated in flowcharts or block diagrams. Here, the computer may be a personal computer (PC), a tablet computer, a smartphone, a workstation, a server computer, or a computer such as a general purpose computer or a special purpose computer, or may be a computer system to which a plurality of computers are connected. Such computer system to which the plurality of computers are connected is also referred to as a distributed computing system, and is a computer in a broad sense. In the distributed computing system, the plurality of computers collectively execute the program by each of the plurality of computers performing a part of the program and passing the data during program execution between the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processor is responsible for executing may be determined statically by multiprocessor-aware programming.

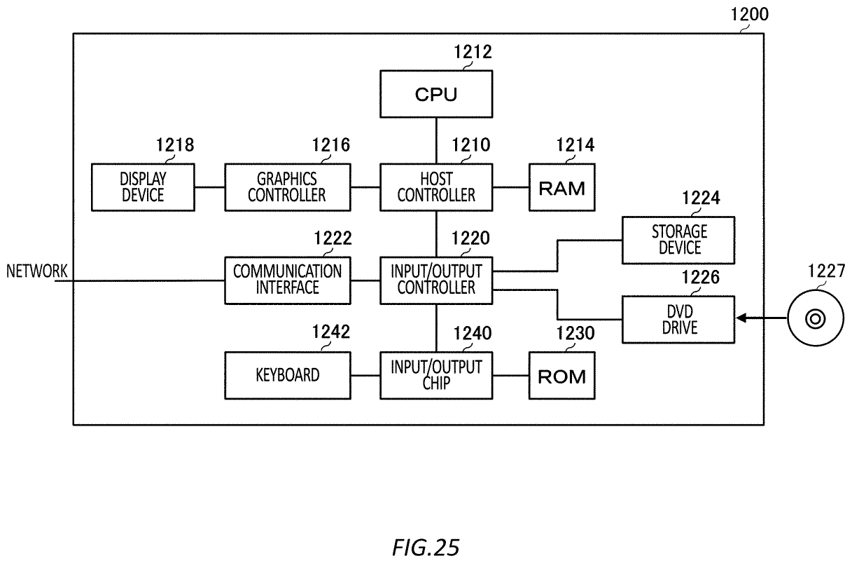

FIG. 25 represents an example of computer 1200 in which a plurality of aspects of the present invention may be wholly or partially embodied. A program that is installed in the computer 1200 can cause the computer 1200 to function as one or more “sections” in an operation or an apparatus associated with the embodiment of the present invention, or cause the computer 1200 to perform the operation or the one or more sections thereof, and/or cause the computer 1200 to perform processes of the embodiment of the present invention or steps thereof. Such a program may be performed by a CPU 1212 so as to cause the computer 1200 to perform certain operations associated with some or all of the blocks of flowcharts and block diagrams described herein.

The computer 1200 in accordance with the present embodiment includes a CPU 1212, a RAM 1214, a graphic controller 1216, and a display device 1218, which are mutually connected by a host controller 1210. The computer 1200 also includes a storage unit 1224 such as a communication interface 1222, a hard disk drive, or the like, an input/output unit such as a DVD-ROM drive 1226 and the IC card drive, which are connected to a host controller 1210 via an input/output controller 1220. The computer also includes legacy input/output units such as an ROM 1230 and a keyboard 1242, which are connected to the input/output controller 1220 via an input/output chip 1240.

The CPU 1212 operates according to programs stored in the ROM 1230 and the RAM 1214, thereby controlling each unit. The graphic controller 1216 obtains image data generated by the CPU 1212 on a frame buffer or the like provided in the RAM 1214 or in itself, and causes the image data to be displayed on a display device 1218.

The communication interface 1222 communicates with other electronic devices via a network. The storage unit 1224 stores the program and data used by the CPU 1212 within the computer 1200. The DVD-ROM drive 1226 reads the program or data from the DVD-ROM 1227 and provides the program or data to the storage unit 1224 via the RAM 1214. The IC card drive reads the programs and the data from the IC card, and/or writes the programs and the data to the IC card.

The ROM 1230 stores therein a boot program or the like that is performed by the computer 1200 at the time of activation, and/or a program depending on the hardware of the computer 1200. The input/output chip 1240 may also connect various input/output units to the input/output controller 1220 via a parallel port, a serial port, a keyboard port, a mouse port, or the like.

Programs are provided by a computer readable medium such as the DVD-ROM 1227 or the IC card. The program is read from the computer readable medium, is installed on a storage unit 1224, a RAM 1214, or a ROM 1230, which are an example of a computer readable medium, and is executed by the CPU 1212. Information processing described in these programs is read by the computer 1200, and provides cooperation between the programs and the various types of hardware resources described above. An apparatus or method may be constituted by realizing the operation or processing of information in accordance with the usage of the computer 1200.

For example, when communication is performed between the computer 1200 and an external device, the CPU 1212 may perform a communication program loaded onto the RAM 1214 to instruct communication processing to the communication interface 1222, based on the processing described in the communication program. The communication interface 1222 reads the transmission data stored in a transmission buffer processing region provided on a recording medium such as a RAM 1214, a storage unit 1224, a DVD-ROM 1227, or an IC card under the control of a CPU 1212, transmits the read transmission data to the network, or writes the reception data received from the network to a reception buffer processing region or the like provided on a recording medium.

The CPU 1212 may cause all or a needed portion of the file or database stored in an external recording medium such as a storage unit 1224, a DVD-ROM drive 1226 (a DVD-ROM 1227), an IC card, or the like to be read to the RAM 1214 and perform various types of processing on the data on the RAM 1214. The CPU 1212 may then write back the processed data to the external recording medium.

Various types of information such as various types of programs, data, tables, and databases may be stored in a recording medium and subjected to information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may retrieve, out of the plurality of entries, an entry with the attribute value of the first attribute specified that meets a condition, read the attribute value of the second attribute stored in said entry, and thereby acquiring the attribute value of the second attribute associated with the first attribute satisfying a predefined condition.

The above-explained program or software modules may be stored in the computer readable media on or near the computer 1200. In addition, a recording medium such as a hard disk or a RAM provided in a server system connected to a dedicated communication network or the Internet can be used as the computer readable media, thereby providing the program to the computer 1200 via the network.

While the present invention has been described with the embodiments, the technical scope of the present invention is not limited to the above-described embodiments. It is apparent to persons skilled in the art that various alterations or improvements can be added to the above-described embodiments. It is also apparent from the description of the claims that the form to which such alterations or improvements are made can be included in the technical scope of the present invention.

It should be noted that the operations, procedures, steps, stages, and the like of each process performed by an apparatus, system, program, and method shown in the claims, the specification, or the drawings can be realized in any order as long as the order is not indicated by “prior to,” “before,” or the like and as long as the output from a previous process is not used in a later process. Even if the operation flow is described by using phrases such as “first” or “next” for the sake of convenience in the claims, specification, and drawings, it does not necessarily mean that the process must be performed in this order.

EXPLANATION OF REFERENCES
10 information processing device;
12 target object;
13 representative plane;
20 data acquisition unit;
30 data processing unit;
32 distance information generation unit;
34 azimuth information generation unit;
36 velocity information generation unit;
38 data cube;
40 conversion condition determination unit;
50 data conversion unit;
60 data output unit;
70 data display unit;
80 identification information acquisition unit;
100 measurement device;
120 transmission unit;
121 transmission antenna;
140 reception unit;
141 reception antenna;
150 intermediate signal;
160 transmission and reception control unit;
170 intermediate signal generation unit;
180 filter unit;
190 AD conversion unit;
220 transmission signal;
230 reception signal;
231 reflected wave;
300 system;
400 measurement range;
402 region;
410 data map;
420 combined data map;
430 display device;
432 indication information;
1200 computer;
1210 host controller;
1212 CPU;
1214 RAM;
1216 graphic controller;
1218 display device;
1220 input/output controller;
1222 communication interface;
1224 storage unit;
1226 DVD-ROM drive;
1227 DVD-ROM;
1230 ROM;
1240 input/output chip;
1242 keyboard.

What is claimed is:

1. An information processing device, comprising:
a data acquisition unit that emits an electromagnetic wave to a target object and acquires measurement data generated from a reflected wave from the target object;
a conversion condition determination unit that determines whether a signal based on the measurement data meets a conversion condition to convert at least a part of the measurement data into sound data; and
a data conversion unit that converts at least a part of the measurement data into the sound data if the signal based on the measurement data meets the conversion condition.

2. The information processing device according to claim 1, where the conversion condition determination unit outputs a control signal to control the electromagnetic wave and the information processing device so that at least one of electric power consumption for emitting the electromagnetic wave or electric power consumption of the information processing device does not change before and after the conversion condition is met.

3. The information processing device according to claim 1, wherein, if the conversion condition is met, the conversion condition determination unit outputs a control signal for controlling at least one of the electromagnetic wave or the information processing device so that at least one of electric power consumption for emitting the electromagnetic wave or electric power consumption of the information processing device increase compared to before the conversion condition is met.

4. The information processing device according to claim 1, wherein, if the conversion condition is met, the conversion condition determination unit outputs a control signal for controlling the electromagnetic wave so that an emission amount of the electromagnetic wave emitted toward the target object increases compared to before the conversion condition is met.

5. The information processing device according to claim 1, wherein the conversion condition determination unit determines whether the conversion condition is met based on the measurement data.

6. The information processing device according to claim 5, wherein the conversion condition determination unit determines whether the conversion condition is met based on an amplitude of the reflected wave included in the measurement data.

7. The information processing device according to claim 5, further comprising a data processing unit that generates distance information indicating a distance to the target object based on the reflected wave included in the measurement data, wherein
the conversion condition determination unit determines whether the distance information meets the conversion condition.

8. The information processing device according to claim 7, wherein the electromagnetic wave includes a chirp signal in which a frequency gradually changes,
the measurement data includes an intermediate signal having a frequency according to a difference between a frequency of the reflected wave and a frequency of the electromagnetic wave.

9. The information processing device according to claim 8, wherein the measurement data includes a plurality of intermediate signals, including the intermediate signal, obtained for each of transmission and reception channels, which is a combination of a transmission antenna of the electromagnetic wave and a reception antenna of the reflected wave,
the data processing unit generates azimuth information indicating an azimuth of the target object from the measurement data for each of the transmission and reception channels, and
the conversion condition determination unit determines whether the reflected wave of each azimuth meets the conversion condition based on the azimuth information.

10. The information processing device according to claim 8, wherein the electromagnetic wave repeatedly includes chirp signals, including the chirp signal,
the measurement data includes the intermediate signal for each of the chirp signals,
the data processing unit generates the distance information for each of the chirp signals,
the data processing unit generates velocity information of the target object from a change among the chirp signals in the distance information, and
the conversion condition determination unit determines whether the measurement data meets the conversion condition based on the velocity information.

11. The information processing device according to claim 1, further comprising a data processing unit that generates distance information indicating a distance to a target object from the measurement data, generates phase shift information from the measurement data, and calculates relative azimuth determination information for the target object based on at least one of an amplitude of the reflected wave, the distance information, or the phase shift information,
the conversion condition determination unit determines whether the relative azimuth determination information meets a conversion condition to convert at least a part of the measurement data into sound data, and
the data conversion unit converts at least a part of the measurement data into the sound data if the relative azimuth determination information meets the conversion condition.

12. The information processing device according to claim 11, wherein, if the relative azimuth determination information does not meet the conversion condition, the conversion condition determination unit generates notification information to notify that the conversion condition is not met.

13. The information processing device according to claim 11, wherein, if the relative azimuth determination information does not meet the conversion condition, the conversion condition determination unit generates indication information that indicates a posture that the target object should assume to meet the conversion condition.

14. The information processing device according to claim 1, further comprising a data processing unit that generates distance information indicating a distance to the target object and azimuth information indicating an orientation of the target object based on the reflected wave included in the measurement data and calculates a relative position of the target object from the distance information and the azimuth information, wherein
the conversion condition determination unit:
generates indication information indicating a direction in which the target object should move if the measurement data in the relative position does not meet the conversion condition; and
converts at least a part of the measurement data into the sound data if the measurement data in the relative position meets the conversion condition.

15. The information processing device according to claim 1, wherein the conversion condition determination unit compares a temporal waveform indicated in the sound data converted from the measurement data to a reference waveform and determines whether the sound data is a body sound.

16. The information processing device according to claim 1, wherein the conversion condition determination unit determines whether the conversion condition is met based on an image of a space to which the electromagnetic wave is emitted.

17. The information processing device according to claim 9, wherein the conversion condition determination unit generates a data map indicating whether the sound data exists for each of azimuths, including the azimuth.

18. The information processing device according to claim 17, wherein the conversion condition determination unit generates the data map for each of different timings and generates a combined data map that indicates whether the sound data exists in at least one of the timings based on a plurality of data maps, including the data map.

19. The information processing device according to claim 1, wherein, if the measurement data does not meet the conversion condition, the conversion condition determination unit generates indication information that indicates a position to which the target object should move to meet the conversion condition.

20. The information processing device according to claim 1, wherein, if the measurement data does not meet the conversion condition, the conversion condition determination unit generates notification information to notify that the conversion condition is not met.

21. The information processing device according to claim 1, further comprising an identification information acquisition unit that acquires identification information for identifying the target object, wherein
the data conversion unit records the sound data and the identification information which are associated with each other.

22. An information processing method, comprising:
emitting an electromagnetic wave to a target object and acquiring measurement data generated from a reflected wave from the target object;
determining whether a conversion condition to convert at least a part of the measurement data into sound data is met; and
converting at least a part of the measurement data into the sound data if the conversion condition is met.

23. A non-transitory computer readable medium having recorded thereon a program which, when executed by a computer, causes the computer to perform operations comprising:
acquiring measurement data generated from a reflected wave from a target object to which an electromagnetic wave is emitted;
determining whether a conversion condition to convert at least a part of the measurement data into sound data is met; and
converting at least a part of the measurement data into the sound data if the conversion condition is met.
